(19) United States
(12) Patent Application Publication
(10) Pub. No.: US 2026/0111928 A1
(43) Pub. Date: Apr. 23, 2026

(54) Advertisement free media entertainment credit system and media market place AFMECS and MMP, to access media entertainment, games, AR/VR services/games, streaming services, temporarily without any advertisement for free across different platforms using the new credit and trade, publish media.

(71) Applicant: Navtej Singh Dhillon, Supply, NC (US)

(72) Inventor: Navtej Singh Dhillon, Supply, NC (US)

(21) Appl. No.: 18/918,755

(22) Filed: Oct. 17, 2024

(51) Int. Cl. G06Q 30/0226

(52) U.S. Cl. CPC G06Q 30/0232

(57) ABSTRACT

Intend to invent and create, advertisement free media entertainment credit system and media market place, which will enable an end user to access media entertainment, games, AR/VR, streaming services, on any platform, temporarily without any advertisements, where otherwise advertisements are shown. The system will build advertisement free media credit based on a users different usage of products, services, promotions on other products and services that give free media credit. Buying products that will give this credit and will apply on the platform of users liking to not show the advertisements without paying to not show the advertisements rather using the credit. This system will embedded many media systems underneath making it a universal cross media platform market place also powered by digital token, enabling media trade and publishing across platforms.

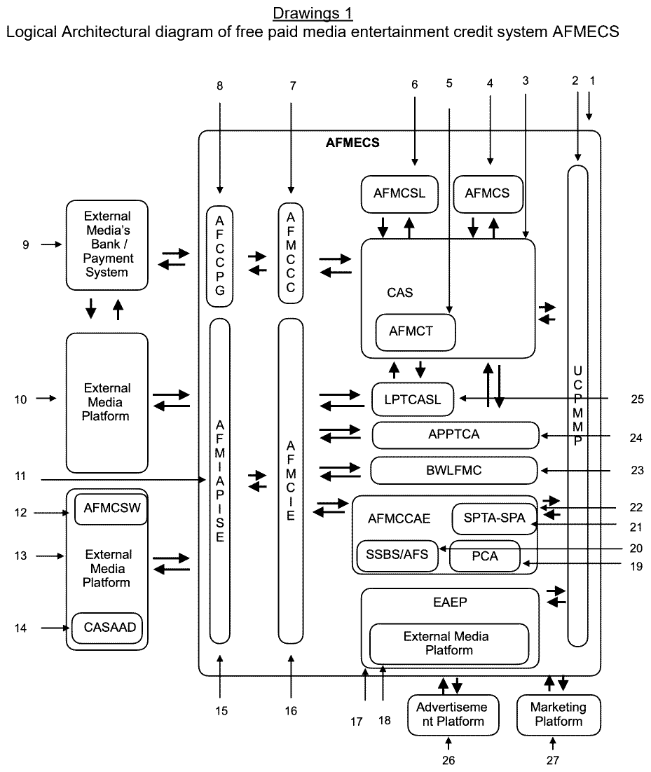

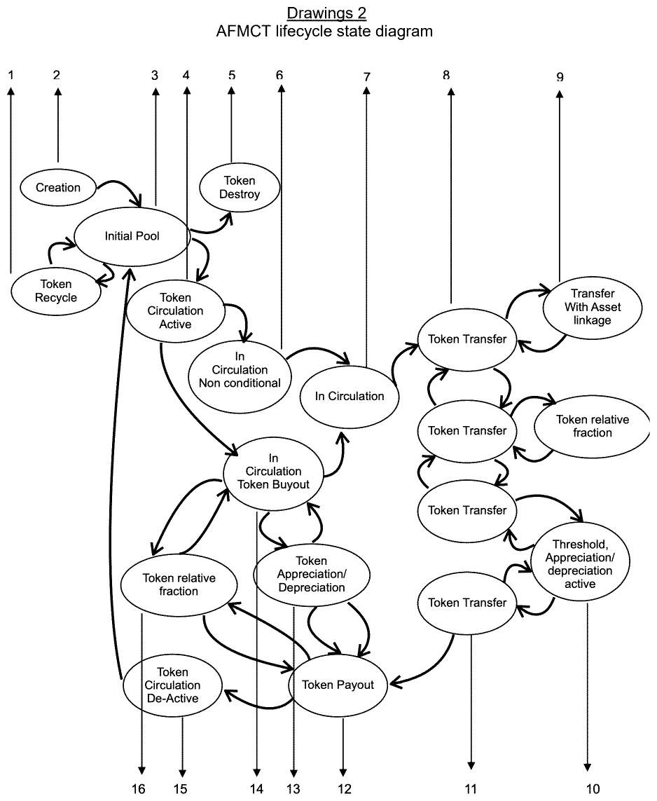

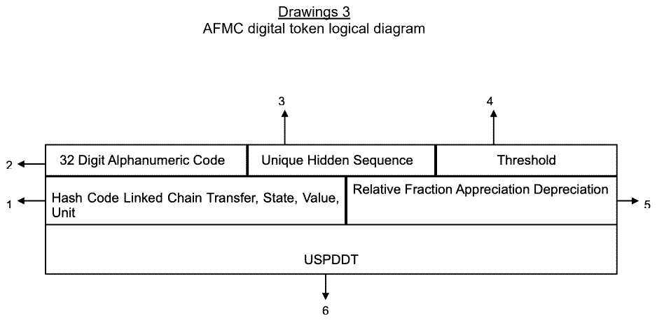

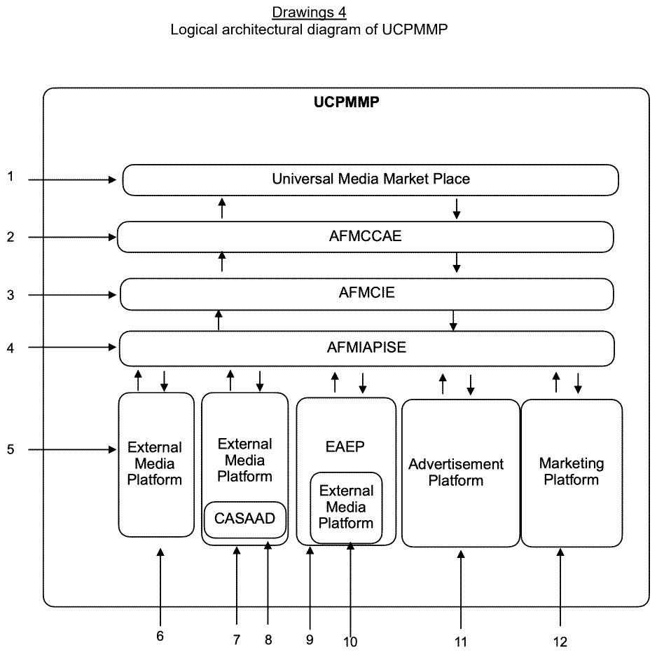

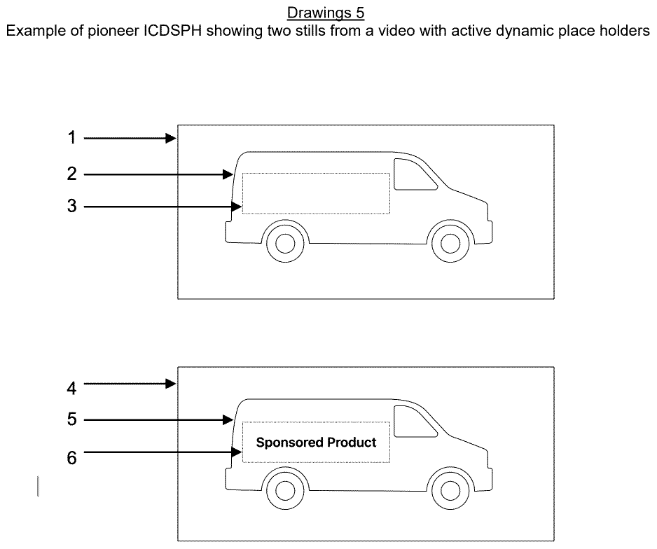

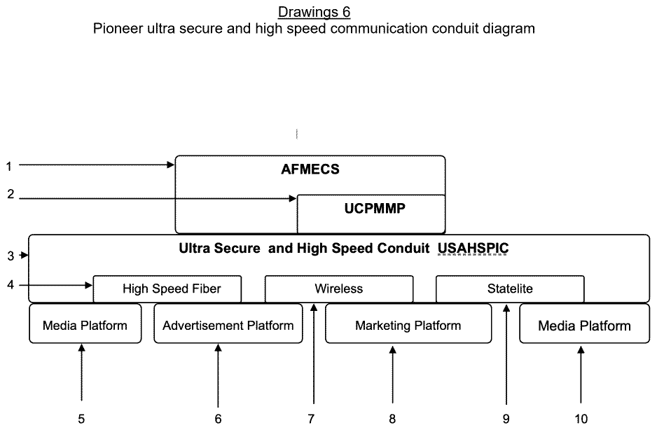

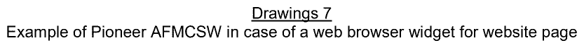

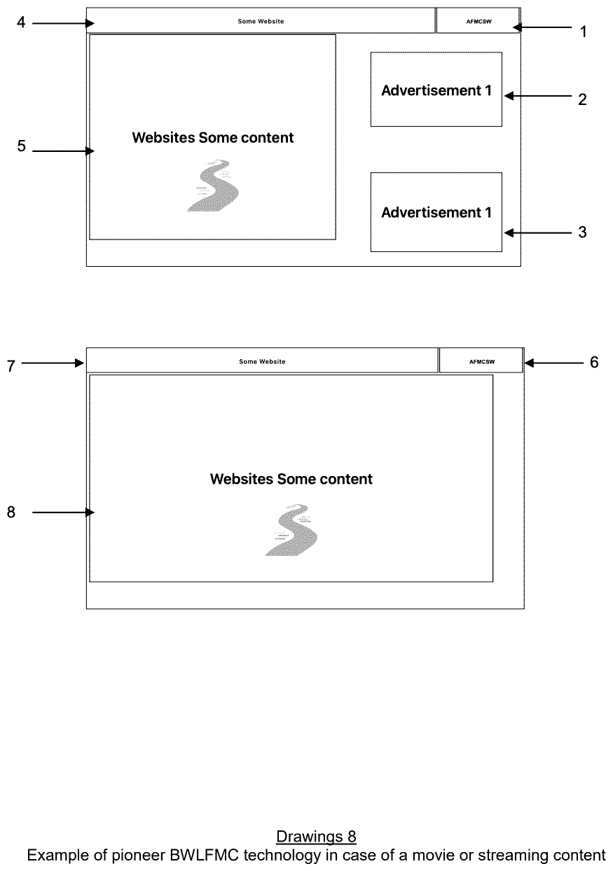

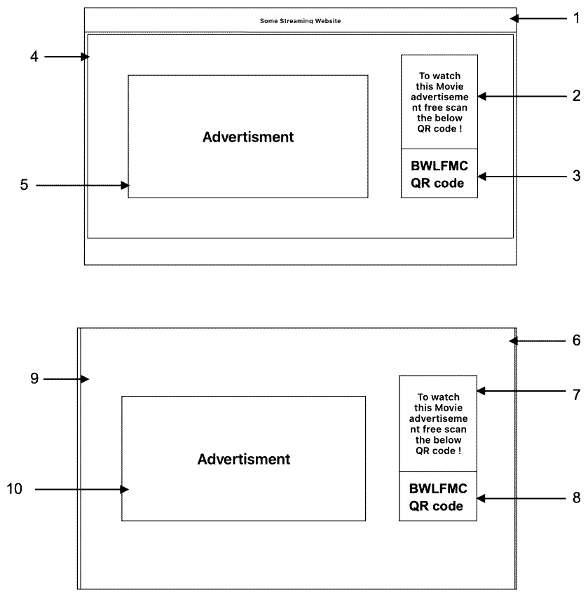

### CROSS-REFERENCE TO RELATED APPLICATIONS

This application takes advantage of the provisional filled application.

Application No: 63/666,659

Patent Application Type: Provisional

### BACKGROUND OF THE INVENTION

B.1 Currently some of the premier media services like premier TV stations, premier streaming services, premier websites, mobiles, tablets, AR/VR services, games, are only accessible when advertisement are shown as part of the content, for most of which an end user have to buy the subscription or rent or pay one time fee or pay for the content to access without advertisements.

B.2 Currently for different platforms like YouTube, TV stations, streaming services, Web browsers, websites, mobiles, tablets, AR/VR services, games, etc, different advertisements are shown and the end user have to watch or listen or play or access to those advertisements as part of the content. To not to watch the advertisements some platforms offer paid subscriptions.

B.3 There does not exists a means by which an end user can access media content temporarily, without buying the subscription or renting or one time pay. A means exists not where an end user can watch the otherwise content without advertisement, temporarily, using some sort of credit which is either acquired or bought or given in promotion.

B.4 As of today different promotions are being offered by manufacturers, stores, shops, media entertainment, service providers etc, which gives an end user some sort of credit, but there exists not a means where a credit system which can temporarily give an end user advertisement free premiere content.

B.5 There exists not a cross platform system which can give an end user credit based on what the end user is watching or using the services or the products or services that are bought, and the same credit can be applied towards accessing the content for advertisement free which otherwise needs to be paid or watched with advertisements.

B.6 There exists not a way which can work across different media platforms, giving the end user the ability to purchase or earn some form of credit once, but be able to apply it across different platforms, end user to access the media content it desires. There exists not a cross platform seamless experience across different media platforms and types.

B.7 There exists not a way where different media content can be traded freely across different platforms and regions, online. There still lacks ways in which the collaboration, and creativity across the regions can be taken to next level.

B.8 No new ways have been found in which advertisements can be shown without interrupting the experience of the entertainment.

B.10 Though the advertisement intent is to promote the products but current advertisement tend to still lack in having a positive influence, there exists not a way where the money spent on advertisement can be more direct and more influential.

B.11 There exists not a fully online media market fully online with collaboration place across different platforms, geographies, where the content can be not only traded freely, royalty be earned directly and nor exist the ability to publish across different platforms without much hassle.

### BRIEF SUMMARY OF THE INVENTION

S.0 Intend to invent and create, advertisement free media entertainment credit system and media market place AFMECS and MMP, to access media entertainment, games, Web browsers, websites, mobiles, tablets, AR/VR services/games, streaming services, temporarily without any advertisement for free across different platforms using the new credit and trade, publish media. Advertisement free media entertainment media credit system and media market place, which will enable an end user to access media entertainment, games, Web browsers, websites, mobiles, tablets, AR/VR, streaming services, on any platform, temporarily advertisement free using the new credit system which otherwise needs to be paid or advertisements needs to be watched. The system will build advertisement free media credit based on a users different usage of products, services, promotions on other products and services that give advertisement free media credit. Buying products that will give this credit and will apply on the platform of users liking to show the advertisement free content without paying rather than using the credit, with news ways accessing the media. This system will embedded many media systems underneath making it a universal fully online cross media platform market place powered by digital token, also giving the end user seamless access to the media of liking by using the new credit system, trading, collaborating and publishing the media content.

S.1 Intend to invent and create, advertisement free media entertainment credit system, which will enable an end user to access media entertainment, games, Web browsers, websites, mobiles, tablets, AR/VR, streaming services, on any platform, temporarily for advertisement free using the credit which otherwise needs to be paid.

S.2 The system will build advertisement free media credit based on a users different usage, promotions that give advertisement free media credit, buying products that will give this credit and will apply on the platform of users liking to show advertisement free content without paying rather than using the credit. The system will comprise of various computer systems, engines, streaming engines, encapsulating engines, GUIs, interfaces and api's that will intact with existing or new media entertainment platforms, marketing and advertisement systems.

S.3 Intend to invent and create cross platform system, which will help end users earn credit, based on the users use of different services, media entertainment services, purchase of products and services, where this credit can be applied on media platforms like YouTube, apple iTunes, games, Web browsers, websites, mobiles, tablets, AR/VR, streaming services, or on any platform etc, to access content temporarily for advertisement free which otherwise needs to be paid or accessed with advertisement.

S.4 The system will accumulate the credit for an end user from different platforms, services the end user use, promotions that give the end user the credit, and for the users liking the system will grant access to content advertisement free by passing the credit to platform where the end user wants to access the content advertisement free.

S.5 The system will give temporary access to the end user to the premiere services using the earned credit which otherwise needs to be paid or accused with advertisements.

S.6 Different manufacturers, stores, shops, media entertainment, etc, can buy advertisement free media content credit, using the system as proposed, and can offer this credit to the end user as promotion, when the end user buys the products or using the service or as a way to increase product awareness. Using the system which will be integrated in different platforms an end user can access the content advertisement free.

S.7 The system as proposed will enable an end user to access media content, advertisement free temporarily, without buying the subscription or renting or one time pay or needing to watch the Sheet 6/48 advertisements, by using the new credit as mentioned.

S.8 The system will work across different platforms, systems, computers systems, mobiles, tablets, Web browsers, websites, mobiles, tablets, AR/VR sets, television sets, and other visual, audio devices, which are being used for entertainment.

S.9 This proposed platform system will give an end user credit based on what the end user is watching or is accessing the service or content, using the services or the products and services that are bought, and the same credit can be applied towards either accessing the content for advertisement free which otherwise needs to be accessed with advertisements.

S.10 There exists not a way which can work across different media platforms, the system as proposed can work across different media and entertainment platforms, giving the end user the ability to purchase or earn some form of credit across systems, but be able to apply it across different platforms, vendors to access the media content it desires.

S.11 The system will create a unique way in which media can be traded across different platform, regions and geographies. Powered by the token as described it will be not only possible to buy the rights to access the media from one platform or the other, but also trade, and gain appreciation gains on the media rights bought, get paid for usage. Also using some of the unique features of the system it will be possible to create new categorization and bundling of the media content to create newer subscriptions and ways the media content can be accessed.

S.12 Using the pioneer real time active content and placeholders as described in detail in the specifications, advertisements can be shown without interrupting the experience of the entertainment and result in much pleasant, positive influence.

S.13 Using the pioneer innovative technique as described in the specification new ways have been shown to promote the product much effectively other than using the advertisement. Also the system as such tries to make the advertisement massage, to have much more positive influence. The system uniquely give direct credit to the end user and money spent on the advertisement is directly transferred to the end user as this new credit, giving access to the user to what is desired making the money spent on advertisement more direct and more influential.

S.14 The system as such build using the new credit token and fully online using the latest high bandwidth technology and other innovative techniques, builds fully online media market place across different platforms, geographies, where the content can be not only traded freely, royalty be earned directly, with very high degree of collaboration and the to publish across different platforms without much hassle.

### BRIEF DESCRIPTION OF THE SEVERAL VIEWS OF THE DRAWING

### DW.1 Drawing 1: Logical Architectural Diagram of Free Paid Media Entertainment Credit System AFMECS

DW.1.1 Drawing 1, is the logical diagram of the “Advertisement Free Media Entertainment Credit System” AFMECS. Listed below are the different parts of the drawing 1, listed from numbers 1 to 27.

DW.1.2 1 Complete AFMECS, is the logical architectural diagram which list all the components in it. Further in detailed description D2 further elaborates that.

DW.1.3 2 is “UCPMMP” is the universal cross platform media market place which integrates and exposes multiple media platforms. Not only the access is seamless, but also the trading between the platforms is seamless. Further with very high bandwidth and super consumable architecture it makes even the non online platform online and all the exchanges are fully online and realtime. Also enabling realtime collaboration, trading, access and publishing.

DW.1.4 3 is CAS credit accumulator system, CAS is center piece of the system, and is the governing agent for advertisement free media credit. It uses the AFMCT token as a means of unit to accumulate credit and uses different modules for its work as further described in D.4.

DW.1.5 4 is AFMSC is free paid media credit store, that holds the AFMCT, as they are acquired by an entity, by an individual, or by a business. Further as described in D.8.

DW.1.6 5 is AFMCT is the digital token, which is the digital representation of the unit of advertisement free media credit, and is unique having a life of its own. The AFMSC, along with CAS, AFMCSL has governing rules for its creation, generation, transfer and conversion to other currencies. Further as described in detail in D.3.

DW.1.7 6 is AFMCSL is advertisement free media credit scale, that will determine the relationship between the AFMCT, number of advertisement free content, the seconds of advertisement free content, the dollar value of the advertisement free content, the dollar value of AFMCT unit, the impact of currency on AFMCT unit, the demand and the prime time impact. Further as described in detail in D.7.

DW.1.8 7 is AFMCCC is advertisement free media credit currency converter, that convert the token to dollar value, for a given currency and vice versa, and uses the AFMCSL for rules. Further as described in detail in D.10.

DW.1.9 8 is AFMCCPG is advertisement free media credit currency payment gateways, and it completes monetary transections between AFMECS, banks, credit cards, businesses. Further as described in detail in D.11.

DW.1.10 9 is External Media's Bank/Payment System. It respects the system or institution the external media platform uses. It is a traditional bank, a payment gateway or a credit card system.

DW.1.11 10 is External Media Platform, is the external media platform or service with which the system interacts with using different modes, and in this particular case as elaborated using the API and streaming engine. Further as described in detail in D.14

DW.1.12 11 and 15 is AFMIAPISE is advertisement free media integration API and streaming engine, using which the system can integrate with any system and can works across any media platform, service or streaming engine. This is API layer on top of the all the components and modules of the AFMECS, as all the components and modules are created with SOA based principle, with the API first approach. It is also responsible to communicate with all the external systems. Further embedded with the API is steaming engine with conversion and interoperability logic, which interfaces with the external systems and does the necessary lightweight conversion of streaming engine of the external platform. Further the detailed description is given in D.14.

DW.1.13 12 is AFMCSW advertisement free media content selector widget, which appears in external media platforms and can enable advertisement free media content on invocation. Further as described in detail in D.18.

DW.1.14 13 is External Media Platform, is another variation of 10, where it is shown the integration is achieved in conjugation with AFMCSW and CASAAD. Further as described in detail in D.14 and D.19.

DW.1.15 14 is CASAAD is CAS agent and adapter, that can be embedded in any media platform, games, web browsers, websites, mobiles, tablets, AR/VR services/games, streaming services and can accumulate the credits based on the usage, or can apply the credit to gain access to the paid content or service. Further as described in detail in D.19.

DW.1.16 11 and 15 is AFMIAPISE, which is advertisement free media integration API and streaming engine. This is API layer on top of the all the components and modules of the AFMECS, as all the components and modules are created with SOA based principle, with the API first approach. It is also responsible to communicate with all the external systems. Further embedded with the API is steaming engine with conversion and interoperability logic, which interfaces with the external systems and does the necessary lightweight conversion of streaming engine of the external platform. Further the detailed description is given in D.14.

DW.1.17 16 is AFMCIE is heavy weight unique conversion engine, with pioneer technologies which can make media exchange and streaming between different media platforms, technologies and consuming devices seamless. Further as described in D.9.

DW.1.18 17 is EAEP which can embedded a platform in it and can embedded multiple platforms in it, giving a homogenous feel and usability to work across different platforms. Further as described in detail in D.15.

DW.1.19 18 is External Media Platform is another variation of 10 and 13, where the integration is complemented using the EAEP.

DW.1.20 19 is PCS per content based access, which grants access to a particular media content or a slice of media service. Further as described in detail in D.21.

DW.1.21 20 is SSBS is sub subscription breakup system which divides a complete subscription from a external media provider into smaller subscriptions based on the part of access to content based on different categorization or duration of the subscription. AFS, is a pioneer subscription which might use SSBS to either remove the advertisements or configure the subscriptions to be more light wight and limited but do not have advertisements. Further as described in detail in D.22.

DW.1.22 21 is SPTA/SPA. Where SPTA subscription pass through which passes the subscription as it is from the external media platform or a part of the subscription, for free media access based on credit. SPA buys a pool of subscription from the external media provider and from this shared pool, manages individual subscriptions to give appropriate access. Further as described in detail in D.20.

DW.1.23 22 is AFMCCAE media content catalog and engine, which manages all the external media platforms, advertisement platforms, marketing platforms and content, and which readily shows all the media platforms, services and media content which is available to access. AFMCCAE further uses SPTA/SPA, SSBS, PCS. Further as described in detail in D.5.

DW.1.24 23 is BWLFMC barcode and QR code with linked advertisement free media content, which generates the barcodes and QR code with linked advertisement free media content, which can be put on product or promotion, it comes with “active on buy” option and becomes only active when the product is bought or service is enabled. Further as described in detail in D.19.

DW.1.25 24 is APPTCA is automatic product purchase to CAS accumulation APPTCA, which automatically accumulates CAS based on the product purchase. Further as described in detail in D.16.

DW.1.26 25 is LPTCASL is loyalty program to CAS linker, that automatically extract the promotions from the products or services a user buys from loyalty program of a company and accumulate the credits to the CAS. Further as described in detail in D.13.

DW.1.27 28 is “Advertisement Platform”, is an example of external advertisement platform.

DW.1.28 29 is “Marketing Platform” and is depicting the external marketing platforms.

### DW.2 Drawing 2: AFMCT Lifecycle State Diagram

DW.2.1 Drawing 2: Depicts the complete life cycle of the AFMCT token from creation to henceforth, each state depicts its functionality and transition to one or other states.

DW.2.2 1 is “Token Recycle” is token recycle state, where the digital code, USPDDT and all the parameters are reset and new token is created altogether. This state is not normally used but only in extreme circumstances, if ever needed.

DW.2.3 2 is “Creation” state is the initialization state, where the token in created the first time. This state is the first state in the AFMCT lifecycle, in this state the new digital code is created along with USPDDT and all the parameters are set to define the new token as such. The “Creation” stage directly leads token to “Initial Pool”.

DW.2.4 3 is “Initial Pool” which represents all the digital tokens complete with all its parameters, USPDDT and ready to get initialized. This state is staging state, and the digital token goes through this stage multiple times over the course of its lifetime. This stage also acts like a reservoir of tokens ready to be used as needed. “Creation”, “Token Circulation De-Active” and “Token Recycle” state transitions a token to “Initial Pool”. From “Initial Pool” a token can transition to “Token Recycle”, “Token Circulation Active” and very extreme case by case to “Token Destroy”.

DW.2.5 4 is “Token Circulation Active” which set the token ready for circulation, and puts the token in circulation. From “Token Circulation Active”, the token can transition to either “In Circulation Non Conditional” or “In Circulation Token Buyout”.

DW.2.6 5 is “Token Destroy” is extremely rare state and under very rare scenarios a digital token is destroyed altogether and all the parameters are reset along with USPDDT. Only from “Initial Pool” a token can transition to “Token Destroy”.

DW.2.7 6 is “In Circulation Non Conditional” is state where the set to active state without any condition, nor any other parameters governing the special features of the token are set. Along with the equivalent value, units, unit to value, token relative fraction is set by going into that state, and also token appreciation/de-appreciation is set. This state is primarily used as the initial creation or subsequent liquidity demand. After this state the token is in circulation and is transitioned to “In Circulation” state.

DW.2.8 7 is “In Circulation” state which signifies that he token is in circulation and the token can go from 1 to n, transfers. From the “In Circulation” state the token goes to “Token Transfer” state.

DW.2.9 8 and 11 is “Token Transfer” state where the token from 1 to n, transfers. Some of the very unique features of the transfer, pertains to transfers with asset linkage, threshold usage on transfer, and appreciation, de-appreciation active. “Token Transfer” state can lead to “Transfer with Asset Linkage”, “Threshold, Appreciation/Depreciation active transfer” and “Token Payout”.

DW.2.10 9 is “Transfer with Asset Linkage” this is the unique state which is interim between the transfer and in this state if the transfer with asset linkage is active, with the very asset affinity, using the threshold, a part of the threshold is used to remit to the asset affinity tokens. This is an interim state with both ends leading to “Token Transfer”

DW.2.11 10 is “Threshold, Appreciation/Depreciation active transfer” this is the unique state which is interim between the transfers and in this state the if threshold is active, a part of the threshold active is remitted to CAS for each transfer, hence each transfer with the asset and participant based on the transfer flow increases the value. If the Appreciation/Depreciation is active based on threshold and asset affinity, the fraction appreciation/depreciation values are set. This is an interim state with both ends leading to “Token Transfer”.

DW.2.12 12 is “Token Payout” is the state where the token is set to deactivated and is removed from circulation, also based on the interim states “Token Appreciation/Depreciation” and “Token Relative Fraction” an appropriate value to remitted and paid out. In this state the token transitions to “Token Relative Fraction” and “Token Appreciation/De-appreciation” and back. After this state the token is in not in circulation and is transitioned to “Token Circulation De-Active” state.

DW.2.13 13 is “Token Appreciation/Depreciation” is the state which is interim in nature, and based on the AFMCSL scale, “Threshold” value remitted and CAS accrued, circulation, demand and transfer with asset linkage, governs and appreciates or depreciates the token value is active. As this is the interim state, the originating and ending state are always the same, which can be, “Token Transfer”, “Token Payout”, “In Circulation Token Buyout”.

DW.2.14 14 is “In Circulation Token Buyout” is state the token is set to circulation with the equivalent value in deposited and the appropriate value is set. Along with the equivalent value, units, unit to value, token relative fraction is set by going into that state, and also token appreciation/de-appreciation is set. Also in this state the “Threshold” transfer factor is set, if active. In this state the token transitions to “Token Relative Fraction” and “Token Appreciation/De-appreciation” and back. After this state the token is in circulation and is transitioned to “In Circulation” state.

DW.2.15 15 is “Token Circulation De-Active” is the state in which the token is not in the circulation anymore, and is transferred to the “Initial Pool”. From this state the token transitions to the “Initial Pool” state.

DW.2.16 16 is “Token Relative Fraction” is the state which is interim in nature, and based on the AFMCSL scale, various parameters are used to the set relative value of the token, pertaining to buyout, payout or transfer. As this is the interim state, the originating and ending state are always the same, which can be, “Token Transfer”, “Token Payout”, “In Circulation Token Buyout”.

### DW.3 Drawing 3: AFMCT Digital Token Logical Diagram

DW.3.1 Drawing 3: Depicts the Logical Diagram of the Digital Token As Such.

DW.3.2 1 is “Hash Code Linked Chain Transfer, State, Value” is is the linked hash code chain, depicting, all the transfers values, parameters at that state, value, units, units to value, states and transitions henceforth.

DW.3.3 2 is “32 Digit Alphanumeric Code” is the unique random code which signifies the token.

DW.3.3 3 is “Unique Hidden Sequence” is the hidden unique increment sequence with the code.

DW.3.3 4 is “Threshold” is the percentage value of the total token value which increases or decreases based on each transfer when active.

DW.3.3 5 is “Relative Fraction Appreciation Depreciation” is the unique set of parameters with the corresponding logic, which is used by CAS, AFMCSL, and where the relative faction is for the state based which is determined based on the relative state and holding party. Whereas appreciation depreciation is set of parameters which signify and govern the tokens appreciation depreciation characteristics.

DW.3.3 6 is “USPDDT” is the ultra secure, temper proof secure technique which makes any transfer creation and circulation ultra secure.

### DW.4 Drawing 4: Logical Architectural Diagram of UCPMMP

DW.4.1 Drawing 4: Depicts the Logical Diagram of the UCPMMP.

DW.4.2 1 is “Universal Media Market Place” is the universal market place which integrates and exposes multiple media platforms. Not only the access is seamless, but also the trading between the platforms is seamless. Further with ultra high bandwidth and super consumable architecture it makes even the non online platform online and all the exchanges are online. Thus the market place makes online collaboration across platforms, regions, and enables to trade and publish content across platforms and regions in realtime. Further as described in D.23.

DW.4.3 2 is “AFMCCAE” is advertisement free media content catalog and engine, which manages all the external media platforms and content, and which readily shows all the media platforms, services and media content which is available to access, trade or publish. AFMCCAE further uses SPTA/SPA, SSBS, PCS, AFS. Further as described in detail in D.5.

DW.4.4 3 is “AFMCIE” is heavy weight unique conversion engine, with pioneer technologies which can make media exchange and streaming between different media platforms, technologies and consuming devices seamless. Further as described in D.9.

DW.4.5 4 is “AFMIAPISE” is advertisement free media integration API and light weight streaming engine. This is API layer on top of the all the components and modules of the AFMECS, and external systems, as all the components and modules are created with SOA based principle, with the API first approach. Further embedded with the API is steaming engine with conversion and interoperability logic, which interfaces with the external systems and does the necessary lightweight conversion of streaming engine of the external platform. Further the detailed description is given in D.14.

DW.4.6 5 and 6 is “External Media Platform” is the external media platform or service with which the system interacts with using different modes, and in this particular case as elaborated using the API and streaming engine. Further as described in detail in D.14

DW.4.7 7 and 8 is “External Media Platform/CASAAD” External Media Platform, is another variation of 10, where it is shown the integration is achieved in conjugation with AFMCSW and CASAAD. Further as described in detail in D.14 and D.19.

DW.4.8 9 and 10 is “External Media Platform/EAEP” is another variation of 10 and 13, where the integration is complemented using the EAEP. Further EAEP which can embedded a platform in it and can embedded multiple platforms in it, giving a homogenous feel and usability to work across different platforms. Further as described in detail in D.15.

DW.4.9 11 is “Advertisement Platform” is external advertisement platform with which the system interacts. The system uses the advertisement platforms and data for creating custom rules, which govern the AFMCT unit value, trading and publishing.

DW.4.8 12 is “Marketing Platform” is the external marketing platform which the system interacts. The system pulls in marketing data to get/publish insights, create custom rules, and apply cross region customizations, exposing optimal marketing strategies.

### DW.5 Drawing 5: Logical Diagram of ICDSPH with Example

DW.5.1 Drawing 5: Logical diagram of “In Content Dynamic Sponsorship Place Holders” ICDSPH with an example showing two stills from a video with active dynamic place holders.

DW.5.2 1 is an example of the still from a video, with the active place holder which is empty.

DW.5.3 2 is an example of visual object in the video, in this case its a truck.

DW.5.4 3 is an example of active place holder in this case is a region as marked. In this example it is shown that in the first production, the region is empty and is not populated

DW.5.5 4 is an example of the still from a video, with the active place holder which is empty.

DW.5.6 5 is an example of visual object in the video, in this case its a truck

DW.5.7 6 is an example of active place holder in this case is a “region” as marked. In this example the “region” is dynamic populated with the product that provided the credit to access the content. This is an example of very effective dynamic embedded advertisement without interrupting the access to the experience which ICDSPH achieves.

### DW.6 Drawing 6: Pioneer Ultra Secure and High Speed Communication Conduit

DW.6.1 Drawing 6: Pioneer ultra secure and high speed communication conduit.

DW.6.2 1 “AFMECS”, advertisement free media entertainment credit system, communication with other systems.

DW.6.3 2 UCPMMP, is universal cross platform media market place communication with other systems.

DW.6.4 3 is USAHSPIC, is Ultra Secure and High Speed Conduit, is pioneer and innovative technology, with ability to use multiple channels. This pioneer technology is the backbone of the of ultra high speed and secure transfer of data, making collaboration, trading, publishing and functionality of the system realtime. Various systems as shown connect to the this conduit, and especially with the streaming, media codec interplay, format conversion, it is possible for various other wise non compatible systems to work seamlessly.

DW.6.5 4 “High Speed Fiber” depicting the ultra high bandwidth and high speed fiber channel.

DW.6.6 5 and 10 “External Media platform” is an example of external media platform.

DW.6.7 6 “Advertisement Platform”, is an example of external advertisement platform.

DW.6.8 7 “Wireless” is the depicting the wireless channel.

DW.6.9 8 “Marketing Platform” is depicting the external marketing platforms.

DW.6.10 9 “Satellite” is depicting the satellite channel.

### DW.7 Drawing 7: Logical Diagram of AFMCSW with Example

DW.7.1 Drawing 7: Logical diagram of “Advertisement Free Media Content Selector Widget” AFMCSW with an example showing two states from website page and AFMCSW widget on a web browser. State 1 is when website webpage has advertisements and state 2 is when AFMCSW is activated and on the same webpage the advertisements are not shown.

DW.7.2 1 Is state 1. showing the hosting software, as in this case is a web browser on which AFMCSW is added as widget or extension. AFMCSW can be placed in any media content provider or hosting software as in this case it is a web browser.

DW.7.3 2 and 3 is an example of advertisements as is shown on the website page.

DW.7.4 4 is an example of a website page which has advertisements.

DW.7.5 5 is an example of the content that is being displayed.

DW.7.6 6 and 7 is the state of 2 of the above.

DW.7.7 8 is state 2 showing the same content but with no advertisements.

### DW.8 Drawing 8: Logical Diagram of BWLFMC with Example

DW.8.1 Drawing 8: Logical diagram of “Barcode and QR code with Linked Advertisement Free Media Content” BWLFMC with an example showing two different examples. Example 1 shows the streaming media content a movie in this case, in a web browser. Example 2, shows a movie in case of TV. In both the example the still is when an advertisement is being shown. As this advertisement has BWLFMC, what is shown is an instruction is also being sown to the user with the corresponding QR code which the end user can scan and skip all the advertisements after this one, and see the rest of the content a movie in this case advertisement free.

DW8.2 1 is an example showing a particular website with steaming content in it.

DW.8.3 2 is an example of instruction advising the user that, advertisements can be skipped if some advertisement free credit.

DW.8.4 3 is an example of the QR code that can be scanned to skip the advertisements after applying the advertisement free credit.

DW.8.5 4 is an the content that is paused and is not visible and in this case it is a movie.

DW.8.6 5 is an example advertisement that is being displayed interrupting and pausing the content to show the advertisement massage.

DW.8.7 6 is the example of the hosting platform that is showing the content in this case it is a TV.

DW.8.8 7 is an example of instruction advising the user that, advertisements can be skipped if some advertisement free credit.

DW.8.9 8 is an example of the QR code that can be scanned to skin the advertisements after applying the advertisement free credit.

DW.8.10 9 is an the content that is paused and is not visible and in this case it is a movie.

DW.8.11 10 is an example advertisement that is being displayed interrupting and pausing the content to show the advertisement massage.

### DESCRIPTION

### Detailed Description of the Invention

P Intend to invent and create, advertisement free media entertainment credit system and media market place AFMECS and MMP, to access media entertainment, games, Web browsers, websites, mobiles, tablets, AR/VR services/games, streaming services, temporarily without any advertisement for free across different platforms using the new credit and trade, publish media. The system builds advertisement free media credit based on a users different usage of products, services, promotions on other products and services that give free media credit, or buy the credit. Buying products that give this credit and apply's on the platform of users liking to show the paid content without paying rather than using the credit. This system embed many media systems underneath making it a universal cross media platform market place powered by digital token, also giving the end user seamless access to the media of liking by using the new credit system, collaborating, trading media or publishing across systems in realtime.

P.1 Intend to invent and create, advertisement free media entertainment credit system, which enables an end user to access media entertainment, games, websites, mobiles apps, tablets apps, AR/VR, streaming services, on any platform, temporarily advertisement free using the credit which otherwise needs to be accessed with advertisements or paid for to not watch the advertisements. The system will comprise of various computer system, engines and api's that will intact with existing or new media entertainment platforms, marketing and advertisement systems.

P.2 Intend to invent and create cross platform system, which helps end users earn credit, based on the users use of different services, media entertainment services, purchase of products and services, where this credit can be applied on media platforms like YouTube, apple iTunes, games, websites, mobiles apps, tablets apps, AR/VR, streaming services, just to name a few, or on any platform etc, to access content temporarily advertisement free which otherwise needs to be paid or access content with advertisement.

P.3 The system accumulates the credit for an end user from different platforms, services the end user use, promotions that give the end user the credit, and for the users liking the system will grant access to advertisement free content by passing the credit to platform where the end user wants to access the advertisement free content or access content without advertisements, which sometimes needs to be paid.

P.4 The system gives temporary access to the end user to the premiere services using the earned credit which otherwise needs to be watched with advertisement or to be paid.

P.5 Different manufacturers, stores, shops, media entertainment, etc, can buy advertisement free credit, using the system as proposed, and can offer this credit to the end user as promotion, or when the end user buys the products. The system which is integrated in different platforms, which an end user can access the content.

P.6 The system as proposed will enable an end user to access media content for advertisement free temporarily which other wise, accessed with the advertisements and without buying the subscription or renting or one time pay, and they can do so by just using the new credit as mentioned.

P.7 The system works across different platforms, systems, computers systems, mobiles, tablets, web browsers, websites, mobiles, tablets, AR/VR sets, television sets, and other visual, audio devices, which are being used for entertainment.

P.8 This proposed platform system gives an end user credit based on what the end user is accessing or watching or playing, using the services or the products and services that are bought, and the same credit can be applied towards accessing the content without advertisements.

P.9 The system also works in real time, just as an example within an content say as the advertisements are displayed, there exists an option where an user can redeem the advertisement free credit and remove the advertisements for the remainder of the content, by scanning a QR code which exists on the advertisement and which was inserted in the advertisement by systems as proposed and explained.

P.10 The system is built of various computer systems, having logic and programming, to infer logic of different modules as mentioned below, and to integrate with other platforms. The system uses service oriented architecture SOA and API, with API first approach to expose these modules using AFMIAPISE.

P.11 “DW.1 Drawing 1” explains the logical diagram of the complete system as built. Slightly here is presented the overall overview of the system and is further each sub system and module is described in the individual sub sections, from D1 to D22.

P.12 CAS credit accumulator system, CAS is center piece of the system, and is the governing agent for advertisement free media credit. It uses the AFMCT token as a means of unit to accumulate credit and uses different modules for its work as further described in D.4. CAS is also responsible for the life cycle of AFMCT and its transfer to and from different systems. AFMCT is the digital token, which is the digital representation of the unit of advertisement free media credit, and is unique having a life of its own. The AFMSC has governing rules for its creation, generation, transfer and conversion to other currencies, its relative buying power of advertisement free media content and the appreciation or depreciation pertaining to a particular media platform or content therefore. Further as described in detail in D.3. CAS uses the AFMSC which is advertisement free media credit store, that holds the AFMCT, as they are acquired by an entity, by an individual, or by a business or the initial set pool for the system to start working as described further in D.8.

P.13 CAS and the credit store uses AFMCSL which is advertisement free media credit scale, that determine the relationship between the AFMCT, number of advertisement free content, the seconds of advertisement free content, the value of the advertisement free content, the dollar value of AFMCT, the impact of currency on AFMCT, the demand and the prime time impact. Further its relative buying power of advertisement free media or paid media content for advertisement free purposes, and the appreciation or depreciation pertaining to a particular media platform or content therefore. Further as described in detail in D.7.

P.14 AFMIAPISE is advertisement free media integration API and streaming engine. This is API layer on top of the all the components and modules of the AFMECS, as all the components and modules are created with SOA based principle, with the API first approach, and is also the layer that talks with external platforms. Further embedded with the API is steaming engine with light weight conversion and interoperability logic, which interfaces with the external systems and does the lightweight conversion of streaming engine of the external platform. Further the detailed description is given in D.14.

P.15 CAS uses AFMCCPG which is advertisement free paid credit currency payment gateways, and it completes monetary transections between AFMECS, banks, credit cards, businesses, other media platforms, by using AFMIAPISE, further is uses AFMCCC which is advertisement free media credit currency converter, that convert the token to dollar value, or other token, for a given currency and vice versa, and uses the AFMCSL for rules. The transactions can also be complete using only the AFMCT also, without using any conversion to a currency or henceforth, in that case the conversion is from token to token. Further as described in detail in D.11.

P.16 The other critical sub system is AFMCCAE which is advertisement free media content catalog and engine, which manages all the external media platforms, types of media platforms, type of content, different content, type of access to access the content, categorization of content, subscriptions, durations, per user access, streaming services, games, games services, Web browsers, websites, mobiles, tablets, AR/VR games and services and henceforth. It also has visual GUIs which readily shows all the media platforms, services and media content which is available to access. AFMCCAE also manages the content, its value in terms of credit token, duration, unit of access per token and both AFMCCAE and CAS work in tandem to get the content and give access to the end users. AFMCCAE further uses SPTA/SPA, SSBS, PCS, AFS, for different categorization of content access from the external media platforms. Where most common external content managing and access techniques implemented are SPTA/SPA, SSBS, PCS, AFS. SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the the new credit system the user might be entitled to only 10 days of the subscription of a service which is billed month to month normally. In this case the the system will give access to the user for 10 days out of the month's subscription and will use the remaining days of the subscription to another eligible user. Further as described in detail in D.20. The PCS per content based access, which grants access to a particular media content or a slice of media service and is most commonly used, for example consider access to one particular movie or a AR/VR game. Further as described in detail in D.22. Further SSBS is sub subscription breakup system which divides a complete subscription from a external media provider into smaller subscriptions based on the part of access to content based on different categorization or duration of the subscription. To give an example say a “L” subscription has access to “p” number of games of television, SSBS can generate custom rules to divide into “n” number of smaller subscriptions having access to “y” number of games. Further as described in detail in D.21. AFS, is a pioneer subscription which might use SSBS to either remove the advertisements or configure the subscriptions to be more light wight and limited but do not have advertisements. Further as described in D.21

P.17 The system as such as described in Drawing 1, uses two other modes by which advertisement free media credit is invoked in the external system. AFMCSW advertisement free media content selector widget, which appears in external media platforms and can enable advertisements free media content on invocation. Further as described in detail in D.18. Where as CASAAD is CAS agent and adapter, that can be embedded in any media platform, games, web browsers, websites, mobiles, tablets, AR/VR services/games, streaming services, web browsers, mobiles, tables and can accumulate the credits based on the usage, or can apply the credit to gain access to the content or service or remove advertisements all together. Further as described in detail in D.19.

P.18 Lastly the system as such has the ability to embed the external media system in it, using the EAEP which can embed a platform in it. It can further embed multiple platforms in it, giving a homogenous feel and usability to work across different platforms. Further as described in detail in D.15.

P.19 AFMECS striking feature is that it gives advertisement free credit benefits on buying of the products. And especially is beneficial to a company or a retail store or a business or entity, which wants gain customer loyalty through “Direct Impact Promotions™” by giving advertisement free media credit as promotion. Consider a scenario, e.g. say a drinks company wants to give a promotion, where if an end user buys “n” number of cases, they get to see a famous movie for advertisement free, using the free paid media credit, which the company as such buys the credit from AFMECS and gives to customer. This functionality is achieved through BWLFMC, which barcode and QR code with linked advertisement free media content, this system generates the barcodes and QR code with linked advertisement free media content, which can be put on product or promotion, it comes with “active on buy” option and becomes only active when the product is bought or service is enabled. Further as described in detail in D.19. Further on same lines APPTCA is automatic product purchase to CAS accumulation APPTCA, which automatically accumulates CAS based on the product purchase. Further as described in detail in D.16.

P.20 Also the system also work across loyalty programs of a product, manufacturer or retail store or online store using the LPTCASL, which is loyalty program to CAS linker, that automatically extract the promotions from the products or services a user buys from loyalty program of a company and accumulate the credits to the CAS.

P.21 The system as such will also enable other unique features, one being “interplatform content trading”, the system as such will make one universal platform for content purchase and repurchase, allowing vendors to make custom subscriptions and henceforth. The other feature being “Content resalable monetary retained value” e.g. say at a particular time, if a content is published and x number of tokens units were used to buy as a unit for y number of access rights, and as the demand for content increases, the bought access rights can be resold at a higher price. Interoperability with any media or content provider. The system will be work with any media or content provider. Further described in D.23.

P.22 Using the universal cross-platform media market place UCPMMP, the system will create a unique way in which media can be traded across different platform, regions and geographies. Powered by the token as described it will be not only possible to buy the rights to access the media from one platform or the other, but also trade, and again appreciation gains on the media rights bought. Also using some of the unique features of the system it will be possible to create new categorization and bundling of the media content to create newer subscriptions and ways the media content can be accessed. Further described in D.23.

P.23 As the goal of the system is to achieve highest Interoperability, the libraries of the system is implemented in multiple programming languages. The first implementation being in python, then java, c #with native functionality in C, C++, VC++. The interfaces written in cross platform frameworks, with mobile responsive and AR/VR convertible. Web scripting is used with HTML, javascript, ajax just to name a fe, json. The system as built adheres to principles of software as a services, having containerization. The system is also resized as mobile application, tablet application, AR/VR application, web application, desktop application and server application. Further agents of app media streaming protocols implemented which and encapsulated behind the API, and streaming engine. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is the pioneer system which uses extremely high bandwidth, high speed multichannel, with ultra high speed fiber, and satellite channels, with the pioneer ultra conduit technology. Also as is implemented as SAAS in multi region, communication between its different multi region SAAS, across different geographies and countries, enabling to access media and transfer media in almost realtime and is pioneer fully online.

### P.24 GLOSSARY

*APMECS: Advertisement free media entertainment credit system.
*AFMCT: Advertisement free paid media credit token.
*CAS: Credit accumulator system.
*AFMCSL: Free paid media credit scale.
*AFMCS: Free paid media credit store.
*AFMCIE: Free paid media credit integration engine.
*AFMCCC: Free paid media credit currency converter.
*AFMCCPG: Free paid media credit currency payment gateways.
*RTCAE: real time credit application engine.
*LPTCASL: loyalty program to CAS linker.
*CASAAD: CAS agent and adapter.
*AFMIAPISE: Advertisement free media integration API and streaming engine.
*EAEP: Encapsulating and embedding platform.
*APPTCA: Automatic product purchase to CAS accumulation.
*AFMCC: Free media content catalog.
*AFMCSW: Free media content selector widget.
*BWLFMC: Barcode and QR code with linked free media content.
*UCPMMP: Universal cross-platform media market place.

P.25 *Media: Here media is broadly used to entertainment systems/platforms like, streaming services like YouTube, apple iTunes, twitch, Netflix, Azure Cloud, Google Cloud, web browsers, websites, mobiles, tablets, AR/VR systems, television Channels to name a few.

P.26 *Entertainment Media: Here entertainment media is broadly used to entertainment systems like, streaming services like YouTube, apple iTunes, twitch, Netflix, Azure Cloud, Google Cloud, web browsers, websites, mobiles, tablets, AR/VR systems, Television Channels to name a few.

P.27 *“External Media System” or “External Media Platform”: are used to represent the software or technology implementation of the “Media” or “Entrainment Media” as described above.

P.28 Content: Content is broadly used to represent any form of digital content, which can be a song, songs, movie, movies, television, TV apps, game, games, web browsers, websites, mobiles, mobile apps/games, tablet apps/games, tablets, AR/VR apps, AR/VR games, serial, serials, documentary, documentaries, hosting service, cloud compute, cloud storage, any public cloud resource.

P.29 *“Manufacturer” or “Company” or “Retail Store” or “Online Store” Or “External Media System” or “External Media Platform” or “Public Cloud Provider” or “Advertisement Company” or “Marketing Company”: are interchangeably used to represent an entity using the the system for desired result as described.

### D.1 Cross Platform Interoperability

D.1.1 Cross platform inter operability in APMECS is achieved by many unique ways, by its ability to connect with different media systems advertisement systems, marketing systems, in many different ways. Basically APMECS will be able to connect in many different ways with media systems as described. APMECS connect's using, the highly versatile api, the adapter, the integration engine, the embedded mode, the light weight streaming engine, the heavy weight streaming engine or the conduit. This unique feature will allow the APMECS to have wider inter operability.

D.1.2 In the first mode of interoperability is achieved through “advertisement free media integration API and streaming engine AFMIAPISE”. AFMIAPISE which is based on SOA architecture and high customizable API exposes widest range of end points for any platform to connect. Further the RESTful API with expandability support of OData, GraphQL, and other technologies, and by having simultaneous implementations, makes the API high customizable and highly interoperable. All the modules communicate with each other also using the API based approach, further making system highly interoperatable. Further the platform is highly interoperatable as each sub system has private, public, on demand protected interface, making the sub systems also available to connect to external systems sub systems on needed basis. Lastly AFMIAPISE has a streaming engine behind the media access API's with the ability to convert streaming or encapsulate streaming.

D.1.3 In the second mode of “free media content selector widget AFMCSW”, the widget itself is embedded in the external media platform. The widget encapsulates all the functionality, and innovation logic in it. With very simple way to integrate into the platform, that is by simply coping few lines of code for an api invocation, can enable the full feature of AFMECS in a media platform.

D.1.4 The third mode is “CAS agent and adapter” CASAAD, in this, the implementation of the required functionality is achieved by importing the libraries, in the code of the external media platform. With the functionality embedded in the code itself, AFMECS can work more seamlessly in the external media platform.

D.1.5 The system as such will also enable other unique features, one being “interplatform content trading”, the system as such will make one universal platform for content purchase and repurchase, also allowing vendors to make custom subscriptions and henceforth. That will be possible with the all the content being under on digital AFMECS, connected with each other using ultra high bandwidth and speed fiber cable connections. Secondly on single digital token will make the trade, simple and free, with the system able to create the right bundles on content and transfer the ownership of the media as such, across different platforms, geographies and countries. The other feature being “Content resalable monetary retained value” e.g. say at a particular time, if a content is published and x number of tokens with units, were used to buy as a unit for y number of access rights, and as the demand for content increases, the bought access rights can be resold at a higher price with unique feature as described in the sections below. Lastly with the unique threshold value proposition, the media content creator will get paid subsequently over any media content right transfer or access, giving the content creators the right value for their effort. The system work with any media or content provider with above mentioned technology as such.

D.1.6 Further with SSBS which is sub subscription breakup system which divides a complete subscription from a external media provider into smaller subscriptions based on the part of access to content based on different categorization or duration of the subscription, it will be possible to create highly customized content with mix and match across different platforms, systems, and geographies.

### D.2 Detailed Description with Architectural Diagrams and Drawings, Working AFMECS

D.2.1 “DW.1 Drawing 1 is the logical architectural diagram and drawing of the system as built. Further D.3 to D.25 goes into detail about explaining the individual components of the system as built, and also explains how the whole system works with external systems. The system is built of various computer systems, having logic and programming, to inter linking of different modules as mentioned below, and to integrate with other platforms. The system uses service oriented architecture and API, with API first approach to expose these modules using AFMIAPISE

D.2.2 “DW.1 Drawing 1” explains the logical diagram of the complete system as built. Slightly here is presented the overall overview of the system and is further each sub system and module is described in the individual sub sections, from D1 to D25.

D.2.3 CAS credit accumulator system, CAS is center piece of the system, and is the governing agent for free media credit. It uses the AFMCT token as a means of unit to accumulate credit and uses different modules for its work as further described in D.4. CAS is also responsible for the life cycle of AFMCT and its transfer to and from different systems. AFMCT is the digital token, which is the digital representation of the unit of free media credit, and is unique having a life of its own. The AFMSC has governing rules for its creation, generation, transfer and conversion to other currencies, its relative buying power of advertisement free media content and the appreciation or depreciation pertaining to a particular media platform or content therefore. Further as described in detail in D.3 CAS uses the AFMSC which is free paid media credit store, that holds the AFMCT, as they are acquired by an entity, by an individual, or by a business or the initial set pool for the system to start working as described further in D.8.

D.2.4 CAS and the credit store uses AFMCSL which is advertisement free media credit scale, that will determine the relationship between the AFMCT, number of advertisement free content, the seconds of advertisement free content, the value of the advertisement free content, the dollar value of AFMCT, the impact of currency on AFMCT, the demand and the prime time impact. Further its relative buying power of advertisement free media or paid media content for advertisement free purposes, and the appreciation or depreciation pertaining to a particular media platform or content therefore. Further as described in detail in D.7.

D.2.5 AFMIAPISE is advertisement free media integration API and streaming engine. This is API layer on top of the all the components and modules of the AFMECS, as all the components and modules are created with SOA based principle, with the API first approach. Further embedded with the API is lightweight steaming engine with conversion and interoperability logic, which interfaces with the external systems and does the lightweight conversion of streaming engine of the external platform. Further the detailed description is given in D.14.

D.2.6 CAS uses AFMCCPG which is advertisement free media credit currency payment gateways, and it completes monetary transections between AFMECS, banks, credit cards, businesses, other media platforms, by using AFMIAPISE, further is uses AFMCCC which is advertisement free media credit currency converter, that convert the token to dollar value, or other token, for a given currency and vice versa, and uses the AFMCSL for rules. The transactions can also be complete using only the AFMCT also, without using any conversion to a currency or henceforth. Further as described in detail in D.11.

D.2.7 The other critical sub system is AFMCCAE which is advertisement free media content catalog and engine, which manages all the external media platforms, types of media platforms, type of content, different content, type of access to access the content, categorization of content, subscriptions, durations, per user access, streaming services, games, games services, Web browsers, websites, mobiles, tablets, AR/VR games and services and henceforth. It also has visual GUIs which readily shows all the media platforms, services and media content which is available to access. AFMCCAE also manages the content, its value in terms of credit token, duration, unit of access per token and both AFMCCAE and CAS work in tandem to get the content and give access to the end users. AFMCCAE further uses SPTA/SPA, SSBS, PCS, AFS, for different categorization of content access from the external media platforms. Where most common external content managing and access techniques implemented are SPTA/SPA, SSBS, PCS, AFS. SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the the new credit system the user might be entitled to only 10 days of the subscription of a service which is billed month to month normally. In this case the the system will give access to the user for 10 days out of the month's subscription and will use the remaining days of the subscription to another eligible user. Further as described in detail in D.20. The PCS per content based access, which grants access to a particular media content or a slice of media service and is most commonly used, for example consider access to one particular movie or a AR/VR game. Further as described in detail in D.22. Further SSBS is sub subscription breakup system which divides a complete subscription from a external media provider into smaller subscriptions based on the part of access to content based on different categorization or duration of the subscription. To give an example say a “l” subscription has access to “p” number of games of television, SSBS can generate custom rules to divide into “n” number of smaller subscriptions having access to “y” number of games. Further as described in detail in D.21. AFS, is a pioneer subscription which might use SSBS to either remove the advertisements or configure the subscriptions to be more light wight and limited but do not have advertisements. Further as described in D.21

D.2.8 The system as such as described in Drawing 1, uses two other modes by which advertisement free media credit is invoked in the external system. AFMCSW advertisement free media content selector widget, which appears in external media platforms and can enable advertisements free media content on invocation. Further as described in detail in D.18. Where as CASAAD is CAS agent and adapter, that can be embedded in any media platform, games, web browsers, websites, mobiles, tablets, AR/VR services/games, streaming services, web browsers, mobiles, tables and can accumulate the credits based on the usage, or can apply the credit to gain access to the content or service or remove advertisements all together. Further as described in detail in D.19.

D.2.9 Lastly the system as such has the ability to embed the external media system in it, using the EAEP which can embed a platform in it. It can further embed multiple platforms in it, giving a homogenous feel and usability to work across different platforms. Further as described in detail in D.15.

D.2.10 AFMECS striking feature is that it gives advertisement free credit benefits on buying of the products. And especially is beneficial to a company or a retail store or a business or entity, which wants gain customer loyalty through “Direct Impact Promotions™” by giving advertisement free media credit as promotion. Consider a scenario, e.g. say a drinks company wants to give a promotion, where if an end user buys “n” number of cases, they get to see a famous movie for advertisement free, using the free paid media credit, which the company as such buys the credit from AFMECS and gives to customer. This functionality is achieved through BWLFMC, which barcode and QR code with linked advertisement free media content, this system generates the barcodes and QR code with linked advertisement free media content, which can be put on product or promotion, it comes with “active on buy” option and becomes only active when the product is bought or service is enabled. Further as described in detail in D.19. Further on same lines APPTCA is automatic product purchase to CAS accumulation APPTCA, which automatically accumulates CAS based on the product purchase. Further as described in detail in D.16.

D.2.11 Also the system also work across loyalty programs of a product, manufacturer or retail store or online store using the LPTCASL, which is loyalty program to CAS linker, that automatically extract the promotions from the products or services a user buys from loyalty program of a company and accumulate the credits to the CAS.

D.2.12 The system as such will also enable other unique features, one being “interplatform content trading”, the system as such will make one universal platform for content purchase and repurchase, allowing vendors to make custom subscriptions and henceforth. The other feature being “Content resalable monetary retained value” e.g. say at a particular time, if a content is published and x number of tokens units were used to buy as a unit for y number of access rights, and as the demand for content increases, the bought access rights can be resold at a higher price. Interoperability with any media or content provider. The system will be work with any media or content provider. Further described in D.23.

D.2.13 Using the universal cross-platform media market place UCPMMP, the system will create a unique way in which media can be traded across different platform, regions and geographies. Powered by the token as described it will be not only possible to buy the rights to access the media from one platform or the other, but also trade, and again appreciation gains on the media rights bought. Also using some of the unique features of the system it will be possible to create new categorization and bundling of the media content to create newer subscriptions and ways the media content can be accessed. Further described in D.23.

D.2.14 The following applies to the whole system, each sub system and module. As the goal of the system is to achieve highest Interoperability, the libraries of the system is implemented in multiple programming languages. The first implementation being in python, then java, c #with native functionality in C, C++, VC++. The interfaces written in cross platform frameworks, with mobile responsive and AR/VR convertible. Web scripting is used with HTML, javascript, ajax just to name a fe, json. The system as built adheres to principles of software as a services, having containerization. The system is also resized as mobile application, tablet application, AR/VR application, web application, desktop application and server application. Further agents of app media streaming protocols implemented which and encapsulated behind the API, and streaming engine. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is the pioneer system which uses extremely high bandwidth, high speed multichannel, with ultra high speed fiber, and satellite channels, with the pioneer ultra conduit technology. Also as is implemented as SAAS in multi region, communication between its different multi region SAAS, across different geographies and countries, enabling to access media and transfer media in almost realtime and is pioneer fully online.

### D.3 Detailed Description with Architectural Diagrams and Drawings, Working of AFMCT Token

D.3.1 AFMCT is the digital token, which is the digital representation of the unit of free media credit, and is unique having a life of its own. The AFMSC has governing rules for its creation, generation, transfer and conversion to other currencies

D.3.2 AFMCT uses highly secure methods for its creation and one of the most striking is secretive USPDDT method for temper proof creation and transfer. With this method it will be impossible to create, replicate or transfer the token. Further its relative buying power of paid media content and the appreciation or decoration pertaining to a particular media platform or content therefore. CAS uses the AFMSC which is free media credit store, that holds the AFMCT, as they are acquired by an entity, by an individual, or by a business or the initial set pool for the system to start working as described further.

### D.3.3 Digital Token

D.3.3.1 A Digital token is best described as 5 part digital representation as described below.
16 Digit Alpha Numeric Code.
A simple sequence attached to the Alpha Numeric Code.
Hash cain code with state, transfer, threshold value, units, unit to value, appreciation and life cycle.
USPDDT ultra secure, temper proff secure technique.
Digital token to asset value linkage and transfer to accumulation active with threshold.

D.3.3.2 This is a very unique way of digital representation of the token, where some of the unique characteristics of the token will give unique access, and media rights. Further the value of the token is decoupled from the token itself, with the unit of the token. A single token with start with 1 token to 1 unit, but can then increase or decrease in number of units. So there can be different tokens with different number of units in them. Also a unit can be fractional in nature unto 5 places of decimal. And the value of the token is realized by the different parameters threshold, relative royalty and rarity of the token as such. The most interesting and unique being with asset linkage, will give owner ship rights along with the access and decoupled. Also based on the transition and flow, with hash life linkage, the token gives unique propositions when appreciation, de appreciation is active.

D.3.3.3 Drawing 3: Depicts the Logical Diagram of the Digital Token As Such.

D.3.3.4 1 is “Hash Code Linked Chain Transfer, State, Value” is is the linked hash code chain, depicting value, units, units to value, all the transfers values, all the transfers, parameters at that state, states and transitions henceforth.

D.3.3.5 2 is “32 Digit Alphanumeric Code” is the unique random code which signifies the token.

D.3.3.6 3 is “Unique Hidden Sequence” is the hidden unique increment sequence with the code.

D.3.3.7 4 is “Threshold” is the percentage value of the total token value which increases or decreases based on each transfer when active.

D.3.3.8 5 is “Relative Fraction Appreciation Depreciation” is the unique set of parameters with the corresponding logic, which is used by CAS, AFMCSL, and where the relative faction is for the state based which is determined based on the relative state and holding party. Whereas appreciation depreciation is set of parameters which signify and govern the tokens appreciation depreciation characteristics.

D.3.3.9 6 is “USPDDT” is the ultra secure, temper proof secure technique which makes any transfer creation and circulation ultra secure.

### D.3.4 Initial Issuing

For the initial working of the system an “x” amount of the tokens will be issued.

### D.3.5 Types of Token

Tokens will come with some overrides giving different flavors to the token as such. Some of the override are.
Currency Lock—Token can be bought and sold only in the currency it was bough it.
Asset linkage token—Token can appreciate or depreciate in value based on the linked platform or media asset.
Transfer to credit accumulator active or not—this unique feature will credit token to the asset on each positive transfer leading to the increase in the value of the media asset over time.
Threshold, Appreciation/Depreciation active transfer—
   Transfer to transfer
   Transfer to asset
   Transfer to creation
Token Appreciation/Depreciation
Token Relative Fraction

### D.3.6 States of the Token

D.3.6.1 Drawing 2: Depicts the complete life cycle of the AFMSC token from creation to henceforth, each state depicts its functionality and transition to one or other states.

D.3.6.2 1 is “Token Recycle” is token recycle state, where the digital code, USPDDT and all the parameters are reset and new token is created altogether. This state is not normally used but only in extreme circumstances, if ever needed.

D.3.6.3 2 is “Creation” state is the initialization state, where the token in created the first time. This state is the first state in the AFMSC lifecycle, in this state the new digital code is created along with USPDDT and all the parameters are set to define the new token as such. The “Creation” stage directly leads token to “Initial Pool”.

D.3.6.4 3 is “Initial Pool” which represents all the digital tokens complete with all its parameters, USPDDT and ready to get initialized. This state is staging state, and the digital token goes through this stage multiple times over the course of its lifetime. This stage also acts like a reservoir of tokens ready to be used as needed. “Creation”, “Token Circulation De-Active” and “Token Recycle” state transitions a token to “Initial Pool”. From “Initial Pool” a token can transition to “Token Recycle”, “Token Circulation Active” and very extreme case by case to “Token Destroy”.

D.3.6.5 4 is “Token Circulation Active” which set the token ready for circulation, and puts the token in circulation. From “Token Circulation Active”, the token can transition to either “In Circulation Non Conditional” or “In Circulation Token Buyout”.

D.3.6.6 5 is “Token Destroy” is extremely rare state and under very rare scenarios a digital token is destroyed altogether and all the parameters are reset along with USPDDT. Only from “Initial Pool” a token can transition to “Token Destroy”.

D.3.6.7 6 is “In Circulation Non Conditional” is state where the set to active state without any condition, nor any other parameters governing the special features of the token are set. This state is primarily used as the initial creation or subsequent liquidity demand. After this state the token is in circulation and is transitioned to “In Circulation” state.

D.3.6.8 7 is “In Circulation” state which signifies that he token is in circulation and the token can go from 1 to n, transfers. From the “In Circulation” state the token goes to “Token Transfer” state.

D.3.6.9 8 and 11 is “Token Transfer” state where the token from 1 to n, transfers. Some of the very unique features of the transfer, pertains to transfers with asset linkage, threshold usage on transfer, and appreciation, de-appreciation active. “Token Transfer” state can lead to “Transfer with Asset Linkage”, “Threshold, Appreciation/Depreciation active transfer” and “Token Payout”.

D.3.6.10 9 is “Transfer with Asset Linkage” this is the unique state which is interim between the transfer and in this state if the transfer with asset linkage is active, with the very asset affinity, using the threshold, a part of the threshold is used to remit to the asset affinity tokens. This is an interim state with both ends leading to “Token Transfer”.

D.3.6.11 10 is “Threshold, Appreciation/Depreciation active transfer” this is the unique state which is interim between the transfers and in this state the if threshold is active, a part of the threshold active is remitted to CAS for each transfer, hence each transfer with the asset and participant based on the transfer flow increases the value. If the Appreciation/Depreciation is active based on threshold and asset affinity, the fraction appreciation/depreciation values are set. This is an interim state with both ends leading to “Token Transfer”.

D.3.6.12 12 is “Token Payout” is the state where the token is set to deactivated and is removed from circulation, also based on the interim states “Token Appreciation/Depreciation” and “Token Relative Fraction” an appropriate value to remitted and paid out. In this state the token transitions to “Token Relative Fraction” and “Token Appreciation/De-appreciation” and back. After this state the token is in not in circulation and is transitioned to “Token Circulation De-Active” state.

D.3.6.13 13 is “Token Appreciation/Depreciation” is the state which is interim in nature, and based on the AFMCSL scale, “Threshold” value remitted and CAS accrued, circulation, demand and transfer with asset linkage, governs and appreciates or depreciates the token value is active. As this is the interim state, the originating and ending state are always the same, which can be, “Token Transfer”, “Token Payout”, “In Circulation Token Buyout”.

D.3.6.14 14 is “In Circulation Token Buyout” is state the token is set to circulation with the equivalent value in deposited and the appropriate value is set. Along with the equivalent value, token relative fraction is set by going into that state, and also token appreciation/de-appreciation is set. Also in this state the “Threshold” transfer factor is set, if active. In this state the token transitions to “Token Relative Fraction” and “Token Appreciation/De-appreciation” and back. After this state the token is in circulation and is transitioned to “In Circulation” state.

D.3.6.15 15 is “Token Circulation De-Active” is the state in which the token is not in the circulation anymore, and is transferred to the “Initial Pool”. From this state the token transitions to the “Initial Pool” state.

D.3.6.16 16 is “Token Relative Fraction” is the state which is interim in nature, and based on the AFMCSL scale, various parameters are used to the set relative value of the token, pertaining to buyout, payout or transfer. As this is the interim state, the originating and ending state are always the same, which can be, “Token Transfer”, “Token Payout”, “In Circulation Token Buyout”.

### D.3.7 AFMCT Relative Value Factor of Media Platform

When converting from AFMCT to a token of a media platform if the conversion is not dollar to token, a fraction will be applied. Each media platform or service will have non-constant relative fraction which with appreciating and depreciating fractions over time.

### D.3.8 Transfer to and From Dollar, Currency

Currency Lock tokens can be transferred to and from dollar and currency they were bough in.

### D.3.9 Value Retained in Media Content

A special type of token which can have asset to the asset linkage which has digital to asset value linkage and transfer to accumulation active with threshold, will have a thresh hold as defined by the credit scale. And of any asset on with transfer to credit accumulator active with this unique feature will credit token to the asset on each positive transfer leading to the increase in the value of the media asset over time.

Please Note: Token, Digital Token, Digital Credit Token, Advertisement Free Media Credit Token, are used interchangeably.

### D.4 Detailed Description with Architectural Diagrams and Drawings, Working of CAS

D.4.1 CAS credit accumulator system, CAS is center piece of the system, and is the governing agent for advertisement free media credit. It uses the AFMCT token as a means of unit to accumulate credit and uses different modules for its work. CAS along with AFMSC is also responsible for the life cycle of AFMCT and its transfer to and from different systems, and uses different sub systems at it disposal.

D.4.2 CAS business model how CAS is earned:
Manufactures, service providers, buys AFMCT based media content and hand over to end users, as promotion or by buying of services or products which carry free media credit.
By the very usage of services, or access, free media credit is earned.
Loyalty points earned are converted to free paid media credit.
Traditional credit cards points earned by an end user are converted to free paid media.
As free paid media is spent in leads to accumulation of free paid media itself.
End users can buy free paid media credit which gives access to free paid media or significantly free part of the paid media.
As the system is universal cross-platform media market place, as by very nature the content published, can be accessed with lower value as it holds prerelease value, which an end user can buy.

D.4.3 To illustrate, a simple example is presented with the flow as described below:
A product manufacturer or an online store or a retail store, starts a promotion to give access to advertisement free content, eg, access to movie without advertisements. For the purchase of 1 or multiple products.
The product manufacturer selects a list of platforms, and particular content using APMECS
Buys the CAS credit using the APMECS for “n” number of content
Promotion barcode and QR code is generated by the product manufacturer by using APMECS with “active sale purchase”, where the access to the content is only available after the sale.
At the check out the barcode and QR code becomes active
User scans the barcode, QR code and is given access to the content using APMECS.
The user either logs in APMECS or access the content for advertisement free, a movie in this case.

### D.4.4 CAS Accumulator

CAS has multiple ways to accumulated credit based on the usage of the participating service, media platform or system as such or based on unique “transfer to accumulation active with threshold”. The most common form of accumulation of CAS for end user usage is going to be asset usage using the token as such. Further is described in D.3, D.5, D.6, D.7, D.14, D.15, D.16, D.19, D.18, D.19, D.23.

### D.4.5 CAS Interface

CAS has multiple interfaces pertaining to different personas that will interface with the system as such. The interfaces will show the usage, accumulation, values, transfers, balances, history, appreciation, depreciation, AFMCCAE linkage, rule engine customization, relationship lifecycle and more functionality for the working of CAS.

Some of the personas:
End User—consumer
Product Manufacturer
Service Provider
Media Platform Provider
Advertisement Provider
Media Trading users
Media Publishing Users
Universal Media Market Place users
Traditional Credit systems
Banking Systems
Auditors
Development and Support

### D.4.6 CAS to AFMCCAE Linker

CAS to AFMCCAE linker binds the two system using the API.

### D.4.7 CAS to AFMCCAE Rule Generation Engine

CAS to AFMCCAE is the rule engine that ties together the credit and the content. The rule engine have most predefined rules, custom rules and automatic rules. For best exposing the content, with the associated token values. Further the rules define the transections, credit value accumulation, thread value usage on each transfer and the content. Further the categorization, bundling and cross platform purchase and selling is defined by the rules. Detained below are some of the pre-defined rules, where the custom and automatic ones will be defined as the system is used over time.

### D.4.8 CAS to AFMCCAE Rule Generation Engine for Very Specific Content PCS

CAS and AFMCCAE, exposes a custom and an automatic rule engine that will help create rules for the best managing of the PCA. CAS will expose the interface with right token values and associated appreciation and depreciation.

### D.4.9 Cas to AFMCCAE Rule Generation Engine for Advertisement Free Media Credit

CAS and AFMCCAE, exposes a custom and an automatic rule engine that will help create rules for the best managing generating the advertisement free media credit based on both the usage of the system by the end user and also by the threshold token usage on each transfer. Once the credit is accumulate the CAS uses the token store to save the value as earned.

### D.4.10 CAS to AFMCCAE Rule Generation Engine for Subscription SPTA/SPA and PCA

CAS and AFMCCAE, exposes a custom and an automatic rule engine that will help create rules for the best managing of the SPTA/SPA. CAS will expose the interface with right token values and associated appreciation and depreciation.

### D.4.11 Cas to AFMCCAE Rule Generation Engine for SSBS, AFS

CAS and AFMCCAE, exposes a custom and an automatic rule engine that will help create SSBS, AFS based on user usage and for best managing of the SPTA/SPA and PCA. CAS will expose the interface with right token values and associated appreciation and depreciation.

### D.4.12 In Store Purchase to CAS Accumulation

In this case a manufacturer or retailer or online store, might enroll in advertisement free media credit for each product that is bought, hence in this case as products are bought credit is automatically accumulated as described in D.16.

### D.4.13 Product Purchase to CAS Accumulation

In this case a manufacturer might enroll in free media credit for each product that is bought online or otherwise, hence in this case as products are bought credit is automatically accumulated as described in D.16.

### D.4.14 Product Promotion to CAS

In this case a manufacturer might enroll in free media credit for a certain promotion on the product, that is bought online or otherwise, hence in this case as products are bought, the user will get access to either a fixed free media credit or as dictated by the promotion, very specific content attached to the promotion. Further as explained in D.19.

### D.4.15 Product Promotion to CAS Action to Certain Content Access

In this case service provider or media provider might enroll is CAS to content access, in this case as the end user accesses certain content the user accumulates free media credit. Further as explained in D.19.

### D.4.16 Custom and Automatic Rules

More custom and automatic rules are created based on different scenarios mentioned in this doc an upon user usage.

### D.5 Detailed Description with Architectural Diagrams and Drawings, Working of External Media Content Catalogue AFMCCAE

D.5.1 AFMCCAE is media content catalog and engine, which manages all the external media platforms and content, and which readily shows all the media platforms, services and media content which is available to access. It manages all the external media platforms, types of media platforms, type of content, different content, type of access to access the content, categorization of content, subscriptions, durations, per user access, streaming services, games, games services, web browsers, websites, mobiles, tablets, AR/VR games and services and henceforth. Further it categorically shows the advertisement free paid media for access. Further AFMCCAE further uses SPTA/SPA, SSBS, PCS, AFS to apply free paid media credit, by working in tandem with CAS, participating systems, media platforms, advertisement platforms, marketing platforms etc. Lastly based on the above mentioned, the AFMCCAE manages the buying rights for the contents and the services henceforth.

D.5.2 The type of media content and media platforms are:
Games
Media Channel
Music Platform e.g. YouTube, iTunes
Video Platform
Games Platform
Live music platforms
Music Radio station
Streaming Service
Music Streaming Service e.g. Twitch
Video streaming service
Web browsers, websites, mobiles, tablets, AR/VR platform
AR/VR streaming service
AR/VR games
Websites
Paid Websites
Cloud Services
Digital Content
Paid Websites
News
Social Media like Facebook, Instragram, Tick tock
Social Media News

D.5.3 Type content that credit can be applied to: the Types wiz:
Minutes of subscription
Hours of Subscription
Days of Subscription
Months of Subscription
Minutes of usage of service
Hours of usage of service
Days of usage of service
Months of usage of service
Access to the a particular media content
Access to bucket of media content
Access to full content under the subscription
Access to a part under the full content under the subscription
Access to the custom part of content under the full subscription
Creating own bucket or subscription
New kind of subscriptions with no advertisements

D.5.4 It also has visual GUIs which readily shows all the media platforms, services and media content which is available to access. AFMCCAE also manages the content, its value in terms of credit token, duration, unit of access per token and both AFMCCAE and CAS work in tandem to get the content and give access to the end users. AFMCCAE further uses SPTA/SPA, SSBS, PCS, for different categorization of content access from the external media platforms. Where most common external content managing and access techniques implemented are SPTA/SPA, SSBS, PCS, AFS. SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the the new credit system the user might be entitled to only 10 days of the subscription of a service which is billed month to month normally. In this case the the system will give access to the user for 10 days out of the month's subscription and will use the remaining days of the subscription to another eligible user. Further as described in detail in D.20. The PCS per content based access, which grants access to a particular media content or a slice of media service and is most commonly used. Further as described in detail in D.21. Further SSBS is sub subscription breakup system which divides a complete subscription from a external media provider into smaller subscriptions based on the part of access to content based on different categorization or duration of the subscription. To give an example say “a” subscription has access to “p” number games of television, SSBS can generate custom rules to divide into “n” number of smaller subscriptions have access to “y” number of games. SSBS also exposes the functionality to the end user where they can mix and match content across different platforms and engine to create sub subscriptions or bucket of content to show as subscription. AFS, is a pioneer subscription which might use SSBS to either remove the advertisements or configure the subscriptions to be more light wight and limited but do not have advertisements. Further as described in detail in D.22.

D.5.5 Having a universal token and cross platform operability, gives the platform unique ability to trade and exchange media*, media content, subscriptions, across platform and geographies. Further with the unique SSBS feature gives the ability to mix and match content, lastly with unique features of the token, makes free trade possible across systems and with threshold feature, gives tremendous payouts to the content creators. Further as described in D.3, D.22, D.23

### D.6 Detailed Description with Architectural Diagrams and Drawings, Working of External Media Advertisement Free Credit Applying Widget EMAFCAW

D.6.1 External Media advertisement free credit applying widget, is a functionality unit or widget that will appear on the external media content platform, using which a user can readily apply the advertisement free paid media credit and can access the content without advertisement which other wise needs to be accessed with advertisements.

D.6.3 Further it acts as CAS accumulator, when embedded in media platform, games, web browsers, websites, mobiles, tablets, AR/VR services/games, streaming services and can accumulate the credits based on the usage, or can apply the credit to gain access to the paid content or service.

### D.7 Detailed Description with Architectural Diagrams and Drawings, Working AFMCSL

D.7.1 CAS and the credit store uses AFMCSL which is media credit scale, that will determine the relationship between the AFMCT, number of units, number of advertisement free content, the seconds of advertisement free content, the dollar value of the advertisement free content, the dollar value of AFMCT, the impact of currency on AFMCT, the demand and the prime time impact. Further its relative buying power of advertisement free media content and the appreciation or depreciation pertaining to a particular media platform or content therefore. AFMCSL is the delicate link between the CAS, AFMCT, the media platforms, the advertisement platforms, marketing platforms, manufacturers, retail stores, etc, digesting in financial, advertisement, marketing, media data, and showing in to create the right rule for advertisement free content slices and at the same time create automatic rules from the data as such. Hence, AFMCSL has set of predefined rules, custom rules and automatic rules based on usage, which are invoked by the different states of the AFMCT, as invoked by CAS. The most important states where AFMCSL has most rules are “Token relative fraction”, “Token Appreciation/Depreciation”, “Transfer With Asset linkage”, “Threshold, Appreciation/depreciation active”, “In Circulation Token Buyout” and “Token Payout”.

D.7.2 CAS uses AFMCCPG which is advertisement free media credit currency payment gateways, and it completes monetary transections between AFMECS, banks, credit cards, advertisements platforms, marketing platforms, businesses by using AFMIAPISE, further is uses AFMCCC which is free paid media credit currency converter, that convert the token to dollar value, for a given currency and vice versa, and uses the AFMCSL for rules.

### D.8 Detailed Description with Architectural Diagrams and Drawings, Working AFMCS

D.8.1 AFMSC is advertisement free media credit store, that holds the AFMCT, as they are acquired by an entity, by an individual, or by a business or media platform or advertisement platform or marketing platform. Almost all the states of the AFMCT are realized through the AFMSC in conjunction with CAS. AFMSC also holds all the financial and transactional information for an entity, which can be a media platform, a manufacturer, an end user, a system user or financial institution or media platform or advertisement platform or marketing platform as such. AFMSC works in tandem with the CAS for the state management for AFMCT, as invoked by the AFMCCAE.

D.8.2 The AFMSC has governing rules for its creation, generation, transfer and conversion to other currencies, its relative buying power of advertisement free media content and the appreciation or depreciation pertaining to a particular media platform or content therefore.

### D.9 Detailed Description with Architectural Diagrams and Drawings, Working AFMCIE

D.9.1 AFMCIE is heavy weight unique conversion engine, with some pioneer technologies which can make media exchange and streaming between different media platforms, technologies and consuming devices seamless. Though AFMIAPISE has some capabilities of conversion between different media platforms and their technologies, but is very lightweight and can be used in only scenarios where there is not a big miss match between to and fro technologies. Where as AFMCIE is specifically made to only take care care of conversions and achieve 100% interoperability and make interaplatform content trading seamless.

D.9.2 Mentioned below are some of the conversions:
Static content to streaming.
Conversion through intermediary storage.
Analog to digital.
Digital to digital with bandwidth optimization for low or high bandwidth.
Steaming technology 1 to streaming technology 2.
Fixed streaming to AR/VR and vice versa.
Access with encapsulation with continuous conversion.

D.9.3 As shown in Diagram 1, and 2. A typical communication starts with AFMIAPISE, using HTTP/TCP protocols. AFMIAPISE does set up the framework where the light weight engine is invoked if needed which passes on the stream or content as needed, and can do some conversion.

D.9.4 Further if the two parties, that is either the media platforms and media platform or media platform or AFMECS, are not compatible, in that case AFMIAPISE sets up the framework and passes control to AFMCIE which uses not only TCP, UDP, but other media specific and latest protocols, to apply all the different methodologies mentioned above.

### D.10 Detailed Description with Architectural Diagrams and Drawings, Working AFMCCC

D.10.1 AFMCCC is media credit currency converter, that convert the token to dollar value, for a given currency and vice versa, and uses the AFMCSL for rules. Typically as replicated by the state of AFMCT, “Token Payout” or “Token Buyout” in case monetary online cash is involved. The AFMCT has a value denoted by the unit part after the state which is communicated to the AFMECS and the transaction with financial institution as by the AFMCS for that entity.

### D.11 Detailed Description with Architectural Diagrams and Drawings, Working AFMCCPG

D.11.1 AFMCCPG is media credit currency payment gateways, and it completes monetary transections between AFMECS, banks, credit cards, businesses. Typically as represented by the state of AFMCT, “Token Payout” or “Token Buyout” in case monetary online cash is involved, which invokes the AFMCCPG pertaining to the value transection for the entity as invoked by the CAS via AFMCS. The AFMCT has a value part after the state which is communicated to the AFMECS and the transaction with financial institution as by the AFMCS for that entity.??

### D.12 Detailed Description with Architectural Diagrams and Drawings, Working RTCAE

D.12.1 Real time credit application engine, RTCAE, using which credit can be applied in real time to the content that is being shown to stop the advertisements that are being shown and watch the content free of any advertisements, further RTCAE has linkage to QR code, where if an advertisement is being shown and if the QR code is scanned the advertisements for the rest of the content is stopped by applying the credit.

D.12.2 A typical flow is, a product manufacturer or product or an advertisement or marketing company will buy credit, and the system will generate the appropriate QR code which can be embedded in the advertisements. The advertisements as such shows this QR code along side the advertisement, with the new kind of direct benefit credit advertisements and such when the manufacturer's advertisements are being displayed, if the user has the credit, can scan the QR code. Once scanned successfully the system will detect the valid scan, and actively using the RTCAE, change the content mode to not display the advertisement using different techniques mentioned in D.21, D.22, D.23.

### D.13 Detailed Description with Architectural Diagrams and Drawings, Working of LPTCASL

D.13.1 LPTCASL is loyalty program to CAS linker, that automatically extract the promotions from the products or services a user buys from loyalty program of a company and accumulate the credits to the CAS. The linkage is possible using the AFMIAPISE, and using API to LPTCASL linkage of participating manufacturer, store, selling platform's loyalty program and AFMECS.

### D.14 Detailed Description with Architectural Diagrams and Drawings, Working of AFMIAPISE

D.14.1 AFMIAPISE is advertisement free media integration API and streaming engine. This is API layer on top of the all the components and modules of the AFMECS, as all the components and modules are created with SOA based principle, with the API first approach, and is also the layer that talks with external platforms. Further embedded with the API is steaming engine with conversion and interoperability logic, which interfaces with the external systems and does the necessary conversion of streaming engine of the external platform. The system as built adheres to principles of software as a services, having containerization. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable.

D.14.2 AFMIAPISE which is based on SOA architecture and high customizable API exposes widest range of end points for any platform to connect. Further the RESTful API with expandability support of OData, GraphQL, new unique customizable endpoints technology and by having simultaneous implementations, makes the API high customizable and highly interoperable. All the modules communicate with each other, also use the API based approach, further making system highly interoperatable. Further the platform is highly interoperatable as each sub system has private, public, on demand protected interface, making the sub systems also available to connect to external systems sub systems on needed basis. Lastly AFMIAPISE has a lightweight streaming engine behind the media access API's with the ability to convert streaming or encapsulate streaming.

### D.15 Detailed Description with Architectural Diagrams and Drawings, Working of EAEP

D.15.1 is EAEP which can embed a platform in it and can embedded multiple platforms in it, giving a homogenous feel and usability to work across different platforms. It does so my encapsulating the platform in it or it can extract content from the host system, regroup them and reshow it sub shared interface, doing so for multiple platforms give it a feeling as there are multiple platforms embedded in it.

### D.16 Detailed Description with Architectural Diagrams and Drawings, Working of APPTCA

D.16.1 is APPTCA is automatic product purchase or service usage to CAS accumulation APPTCA, which automatically accumulates CAS based on the product purchase. The functionality is achieved with BWLFMC with option APPTCA active which can automatically start accumulating the credit for the users that buy the products in store or online.

### D.17 Detailed Description with Architectural Diagrams and Drawings, Working of BWLFMC

D.19.1 BWLFMC barcode and QR code with linked advertisement free media content, which generates the barcodes and QR code with linked advertisement free media content, which can be put on product or promotion, it comes with “active on buy” option and becomes only active when the product is bought or service is enabled.

D.19.2 A company or a retail store or a business or entity, which wants gain customer loyalty through “Direct Impact Promotions™” by giving advertisement free media credit as promotion, can use BWLFMC. The functionality is described using the scenario e.g. say a drinks company wants to give a promotion, where if an end user buys “n” number of cases, they get to see a famous movie for advertisement free, using the advertisement free media credit, which the company as such buys the credit from AFMECS and gives to customer. This functionality is achieved through BWLFMC, which barcode and QR code with linked advertisement free media content, this system generates the barcodes and QR code with linked advertisement free media content, which can be put on product or promotion, it comes with “active on buy” option and becomes only active when the product is bought or service is enabled. When the end user scans the QR code the system shows the appropriate instructions to the end user to access the media content advertisement free. Behind the scene the system interacts with the participating, promotion providing entity, advertisement platform, media platform and does the appropriate AFMCT transections.

D.19.3 Drawing 8: Logical diagram of “Barcode and QR code with Linked Advertisement Free Media Content” BWLFMC with an example showing two different examples. Example 1 shows the streaming media content a movie in this case, in a web browser. Example, show a movie in case of TV. In both the example the still is when an advertisement is being shown. As this advertisement had BWLFMC, what is shown is an instruction is also being sown to the user with the corresponding QR code which the end user can scan and skip all the advertisements after this one, and see the rest of the content a movie in this case advertisement free.

D.19.4 1 Is an example showing a particular website with steaming content in it.

D.19.5 2 is an example of instruction advising the user that, advertisements can be skipped if some advertisement free credit.

D.19.6 3 is an example of the QR code that can be scanned to skin the advertisements after applying the advertisement free credit.

D.19.7 4 is an the content that is paused and is not visible and in this case it is a movie.

D.19.8 5 is an example advertisement that is being displayed interrupting and pausing the content to show the advertisement massage.

D.19.9 6 is the example of the hosting platform that is showing the content in this case it is a TV.

D.19.10 7 is an example of instruction advising the user that, advertisements can be skipped if some advertisement free credit.

D.19.11 8 is an example of the QR code that can be scanned to skin the advertisements after applying the advertisement free credit.

D.19.12 9 is an the content that is paused and is not visible and in this case it is a movie.

D.19.13 10 is an example advertisement that is being displayed interrupting and pausing the content to show the advertisement massage.

### D.18 Detailed Description with Architectural Diagrams and Drawings, Working of AFMCSW

D.18.1 AFMCSW advertisement free media content selector widget, which appears in external media platforms which can be any media platform, games, web browsers, websites, mobiles, tablets, AR/VR services/games, streaming services, web browsers, mobiles, tables and can enable advertisement free media content on invocation.

D.18.2 The widget itself is embedded in the external media platform. The widget encapsulates all the functionality, and innovation logic in it. With very simple way to integrate into the platform, that is by simply coping few lines of code for an api invocation, can enable the full feature of AFMECS in a media platform.

D.18.2 Further the widget is embedded in web browsers as an extension. And on innovation, contacts the website that is being displayed, passes on the advertisement free tokens to remove the advertisements from the website. The widget has the option of always on, which actively looks at the website that is opened and tries to removed the advertisement by giving the credit to the website that is being displayed. On same lines the be any media platform, games, web browsers, websites, mobiles apps/games, TV channels, TV content, tablets apps/games, AR/VR services/games, streaming services, web browsers, mobiles, tables. It also has an “always active” option which actively keeps removing the advertisements if possible based on what the end user is accessing.

D.18.3 It also acts as a CAS accumulator, when embedded in media platform, games, web browsers, websites, mobiles, tablets, AR/VR services/games, streaming services and can accumulate the credits based on the usage, or can apply the credit to gain access to the paid content or service.

D.18.4 Drawing 7: Logical diagram of “Advertisement Free Media Content Selector Widget” AFMCSW with an example showing two states from website page and AFMCSW widget on a web browser. State 1 is when website webpage has advertisements and state 2 is when AFMCSW is activated and on the same webpage the advertisements are not shown.

D.18.5 1 Is state 1. showing the hosting software, as in this case is a web browser on which AFMCSW is added as widget or extension. AFMCSW can be placed in any media content provider or hosting software as in this case it is a web browser.

D.18.6 2 and 3 is an example of advertisements as is shown on the website page.

D.18.7 4 is an example of a website page which has advertisements.

D.18.8 5 is an example of the content that is being displayed.

D.18.9 6 and 7 is the state of 2 of the above.

D.18.10 8 is state 2 showing the same content but with no advertisements.

### D.19 Detailed Description with Architectural Diagrams and Drawings, Working of CASAAD

D.19.1 CASAAD is CAS agent and adapter, that can be embedded in any media platform, games, web browsers, websites, mobiles, tablets, AR/VR services/games, streaming services, web browsers, mobiles, tables and can accumulate the credits based on the usage, or can apply the credit to gain access to the content or service or remove advertisements all together.

D.19.2 The implementation of the required functionality is achieved by importing the libraries, in the code of the external media platform. With the functionality embedded in the code itself, AFMECS can work more seamlessly in the external media platform. This agent can simply appear as a button with appropriate text on it, on the media platform or host software also, where the media content is being accessed.

### D.20 Detailed Description with Architectural Diagrams and Drawings, Working of SPTA/SPA

D.20.1 SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the the new credit system the user might be entitled to only 10 days of the subscription of a service which is billed month to month normally. In this case the the system will give access to the user for 10 days out of the month's subscription and will use the remaining days of the subscription to another eligible user.

### D.21 Detailed Description with Architectural Diagrams and Drawings, Working of SSBS/AFS

D.21.1 SSBS is sub subscription breakup system which divides a complete subscription from a external media provider into smaller subscriptions based on the part of access to content based on different categorization or duration of the subscription. To give an example say a “L” subscription has access to “p” number games of television, SSBS can generate custom rules to divide into “n” number of smaller subscriptions have access to “y” number of games. SSBS also exposes the functionality to the end user where they can mix and match content across different platforms and engine to create sub subscriptions or bucket of content to show as subscription. Further with SSBS which is sub subscription breakup system which divides a complete subscription from a external media provider into smaller subscriptions based on the part of access to content based on different categorization or duration of the subscription, it will be possible to create highly customized content with mix and match across different platforms, systems, and geographies.

D.21.2 AFS, is a pioneer subscription which might use SSBS to either remove the advertisements or configure the subscriptions to be more light wight and limited but do not have advertisements.

D.21.3 CPS, cross platform subscription is a pioneer subscription, which can span across multiple cross platform media platform, devices and geographies.

### D.22 Detailed Description with Architectural Diagrams and Drawings, Working of PCS

D.22.1 PCS per content based access, which grants access to a particular media content or a slice of media service. The PCS per content based access, which grants access to a particular media content or a slice of media service and is most commonly used.

### D.23 Detailed Description with Architectural Diagrams and Drawings, Working of UCPMMP

D.23.1 “Universal Media Market Place” is the universal market place which integrates and exposes multiple media platforms. This is the pioneer fully online media marketplace. Not only the access is seamless, but also the trading between the platforms is seamless. Further with very high bandwidth and super consumable architecture it makes even the non online platform online and all the exchanges are online. Also enabling realtime collaboration, trading, access and publishing. The system as such will also enable other unique features, one being “interplatform content trading”, the system as such will make it one universal platform for content purchase and repurchase, allowing vendors to make custom subscriptions and henceforth. The other feature being “Content resalable monetary retained value” e.g. say at a particular time, if a content is published and x number of tokens were used to buy as a unit for y number of access rights, and as the demand for content increases, the bought access rights can be resold at a higher price with unique feature. With above mentioned features the market place makes online collaboration across platforms, regions, and enables to trade and publish content across platforms and regions in realtime.

D.23.2 This pioneer features are possible with the all the content being under on digital AFMCT, connected with each other using ultra high bandwidth and speed fiber cable connections. Secondly on single digital token will make the trade, simple and free, with the system able to create the right bundles on content and transfer the ownership of the media as such, across different platforms, geographies and countries. The other feature being “Content resalable monetary retained value” e.g. say at a particular time, if a content is published and x number of tokens were used to buy as a unit for y number of access rights, and as the demand for content increases, the bought access rights can be resold at a higher price with unique feature as described in the section. Lastly with the unique threshold value proposition, the media content creator will get paid subsequently over any media content right transfer or access, giving the content creators the right value for their effort.

D.23.3 Further with SSBS which is sub subscription breakup system which divides a complete subscription from a external media provider into smaller subscriptions based on the part of access to content based on different categorization or duration of the subscription, it will be possible to create highly customized content with mix and match across different platforms, systems, and geographies. CPS, cross platform subscription is a pioneer subscription, which can span across multiple cross platform media platform, devices and geographies.

D.23.4 Further with the unique feature of UCPMMP it will be possible to publish content in the media market place, monetize it and push it all the media platforms with a single simple interface. D.1 also explains how the platform interpretability and the features described in this doc will enable this feature.

D.23.5 The trading agent of the UCPMMP is responsible for making trades across multiple media platform devices, channels and geographies.

D.23.6 The publishing agent of the UCPMMP is responsible for publishing content across multiple media platform devices, channels and geographies.

D.23.7 Drawing 4: Depicts the Logical Diagram of the UCPMMP.

D.23.8 1 is “Universal Media Market Place” is the universal market place which integrates and exposes multiple media platforms. Not only the access is seamless, but also the trading between the platforms is seamless. Further with very high bandwidth and super consumable architecture it makes even the non online platform online and all the exchanges are online. Also enabling realtime collaboration, trading, access and publishing.

D.23.9 2 is “AFMCCAE” is free paid media content catalog and engine, which manages all the external media platforms and content, and which readily shows all the media platforms, services and media content which is available to access. AFMCCAE further uses SPTA/SPA, SSBS, PCS Further as described in detail in D.5.

D.23.10 3 is “AFMCIE” is heavy weight unique conversion engine, with some pioneer technologies which can make media exchange and streaming between different media platforms, technologies and consuming devices seamless. Further as described in D.9.

D.23.11 4 is “AFMIAPISE” is which is free paid media integration API and light weight streaming engine. This is API layer on top of the all the components and modules of the AFMECS, as all the components and modules are created with SOA based principle, with the API first approach. Further embedded with the API is steaming engine with conversion and interoperability logic, which interfaces with the external systems and does the necessary conversion of streaming engine of the external platform. Further the detailed description is given in D.14.

D.23.12 5 and 6 is “External Media Platform” is the external media platform or service with which the system interacts with using different modes, and in this particular case as elaborated using the API and streaming engine. Further as described in detail in D.14

D.23.13 7 and 8 is “External Media Platform/CASAAD” External Media Platform, is another variation of 10, where it is shown the integration is achieved in conjugation with AFMCSW and CASAAD. Further as described in detail in D.14 and D.19.

D.23.14 9 and 10 is “External Media Platform/EAEP” is another variation of 10 and 13, where the integration is complemented using the EAEP. Further EAEP which can embedded a platform in it and can embedded multiple platforms in it, giving a homogenous feel and usability to work across different platforms. Further as described in detail in D.15.

D.4.15 11 is “Advertisement Platform” is external advertisement platform with which the system interacts. The system uses the advertisement platforms and data for creating custom rules, which govern the AFMCT unit value, trading and publishing.

D.4.16 12 is “Marketing Platform” is the external marketing platform which the system interacts. The system pulls in marketing data to get/publish insights, create custom rules, and apply cross region customizations, exposing optimal marketing strategies.

### D.24 Detailed Description with Architectural Diagrams and Drawings, Working of ICDSPH

D.24.1 The in content dynamic sponsorship place holders ICDSPH, which appear in certain places in the media content, that will be replaced by the product or promotion or entity, from which the credit was earned to not show the advertisements, rather show the product that sponsored the content dynamically, this is a pioneer way to inform users about the products and services without interrupting the experience. The drawing shows 5 shows and example of the same as shown below.

D.24.2 Drawing 5: Logical diagram of ICDSPH with an Example showing two stills from a video with active dynamic place holders.

D.24.3 1 is an example of the still from a video, with the active place holder which is empty.

D.24.4 2 is an example of visual object in the video, in this case its a truck.

D.24.5 3 is an example of active place holder in this case is a region as marked. In this example it is shown that in the first production, the region is empty and is not populated

D.24.6 4 is an example of the still from a video, with the active place holder which is empty.

D.24.7 5 is an example of visual object in the video, in this case its a truck

D.24.8 6 is an example of active place holder in this case is a region as marked. In this example it is dynamic populated with the product that provided the credit to access the content. This is an example of very effective dynamic embedded advertisement without interrupting the access to the experience which ICDSPH achieves.

D.24.9 For ICDSPH to work, the media content needs to be created with ICDSPH framework for each media type. Which typically is creating the content with active regions, proving the corresponding ICDSPH aware API/File, active replacement content in case to be promoted product, and re

D.24.10 ICDSPH can work with any media content type, can be anything as described above, and just to name a few can be pictures, video, video games, music, Web browsers, websites, mobiles, tablets, AR/VR services, AR/VR games, any visual or audio media.

D.24.11 ICDSPH mostly uses two modes of creating the ICDSPH active content, one being is reproducing the first production to the second production using ICDSPH framework. Second being active and constant real time insertion of promoted products using ICDSPH system.

### D.25 Detailed Description with Architectural Diagrams and Drawings, Working of Different Sub Systems, Systems, External Systems and Interactions Between Them

D.25 As the goal of the system is to achieve highest Interoperability, the libraries of the system is implemented in multiple programming languages. The first implementation being in python, then java, c #with native functionality in C, C++, VC++. The interfaces written in cross platform frameworks, with mobile responsive and AR/VR convertible. Web scripting is used with HTML, javascript, ajax just to name a few, json. The system as built adheres to principles of software as a services, having containerization. The system is also resized as mobile application, tablet application, AR/VR application, web application, desktop application and server application. Further agents of app media streaming protocols implemented which and encapsulated behind the API, and streaming engine. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is the pioneer system which uses extremely high bandwidth, high speed multichannel, with ultra high speed fiber, and satellite channels, with the pioneer ultra conduit technology. Also as is implemented as SAAS in multi region, communication between its different multi region SAAS, across different geographies and countries, enabling to access media and transfer media in almost realtime and is pioneer fully online.

D.25.2 Further Drawing 6: Pioneer ultra secure and high speed communication conduit

D.25.3 1 “AFMECS”, advertisement free media entertainment credit system, communication with other systems.

D.25.4 2 UCPMMP, is universal cross platform media market place communication with other systems.

D.25.5 3 is USAHSPIC, is Ultra Secure and High Speed Protocol Conduit, is pioneer and innovative technology. This pioneer technology is the backbone of the of ultra high speed and secure transfer of data, making collaboration, trading, publishing and functionality of the system realtime. Various systems as shown connect to the this conduit, and especially with the streaming, media codec interplay, format conversion, it is possible for various other wise non compatible systems to work seamlessly.

D.25.6 4 “High Speed Fiber” depicting the ultra high bandwidth and high speed fiber channel.

D.25.7 5 and 10 “External Media platform” is an example of external media platform.

D.25.8 6 “Advertisement Platform”, is an example of external advertisement platform.

D.25.9 7 “Wireless” is the depicting the wireless channel.

D.25.10 8 “Marketing Platform” is depicting the external marketing platforms.

D.25.11 9 “Satellite” is depicting the satellite channel.

1. Claim to invent and create, advertisement free media entertainment credit system and media market place AFMECS and MMP, to access media entertainment, AR/VR services, streaming services, temporarily without any advertisements using the new credit and also trade media, publish online using the pioneer high bandwidth techniques and technology.

2. Claim to invent and create, media credit token, MCT, that defines the MC token.

3. Claim to invent and create, credit accumulator system, CAS, which have the logic and rules on how the credit will be accumulated, based on the promotions on the products a user buys, coupons a user have, products that give credit, media content that might give credit, usage of products or services which give credit or payment to buy credit.

4. Claim to invent and create, advertisement free media credit scale AFMCSL, for advertisement free content, AFMECSAMMP, that will determine the relationship between the MCT, number of paid content, the seconds of paid content, the dollar value of the paid content, the dollar unit value of MCT, the currency impact on MCT, the prime time impact and demand.

5. Claim to invent and create, media credit store, MCS, that holds the MCT, as they are acquired by an entity, by an individual, by a business, media platform, and henceforth.

6. Claim to invent and create, media credit integration engine, MCIE, that integrates the MCIE with media platforms, marketing systems, advertisement systems, currency systems and banking systems.

7. Claim to invent and create, media credit currency converter, MCCC, that convert the digital token to dollar value, for a given currency and vice versa.

8. Claim to invent and create, media credit currency payment gateways, MCCPG, that completes monetary transections between AFMECS, banks, credit cards, businesses and henceforth.

9. Claim to invent and create, real time credit application engine, RTCAE, using which credit can be applied in real time to the content that is being shown to stop the advertisements that are being shown and watch the content free of any advertisements, further RTCAE has linkage to QR code, where if an advertisement is being shown and if the QR code is scanned the advertisements for the rest of the content is stopped by applying the credit.

10. Claim to invent and create, CAS agent and adapter CASAAD, that can be embedded in any media platform, games, AR/VR services/games, streaming services and can accumulate the credits based on the usage, or can apply the credit to gain access to the content or service without any advertisements.

11. Claim to invent and create, loyalty program to CAS linker, LPTCASL, that will automatically extract the promotions from the products or services a user buys from loyalty program of a company and accumulate the credits to the CAS.

12. Claim to invent and create, media integration API and streaming engine MIAPISE, using which the system can integrate with any system and can works across any media platform, service, or streaming engine, further MCE is a heavy weight unique conversion engine, with pioneer technologies which can make media exchange and streaming between different media platforms, media formats, media protocols, technologies and consuming devices seamless.

13. Claim to invent and create, encapsulating and embedding platform EAEP, which can embedded a platform in it and can embedded multiple platforms in it, giving a homogenous feel and usability to work across different platforms.

14. Claim to invent and create, automatic product purchase to CAS accumulation APPTCA, which automatically accumulates CAS based on the product purchase.

15. Claim to invent and create, media content catalog and engine MCCAE, manages all the external media platforms and content, and which readily shows all the media platforms, services and media content which is available to explore, and can be seen without any advertisements for free using the new credit which otherwise advertisements are shown.

16. Claim to invent and create, advertisement free media content selector widget AFMCSW, which appears in external media platforms and can enable enable free media content on invocation.

17. Claim to invent and create, barcode and QR code with linked advertisement free media content BAQRWLAFMC, which generates the barcodes with linked free paid media content.

18. Claim to invent and create, pioneer advertisement free subscription AFS, which is a special type of subscription specifically designed to not show the advertisements, further advertisement free media access based on credit and per content access PCA, which grants access to a particular content for advertisement free and subscription pass through SPTA, which passes the subscription as it is from the external media platform or a part of the subscription as way to not show advertisements with this subscription and also subscription pool SPA, with sub subscription breakup system SSBS, which shares a pool of subscription from the external media provider and further SSBS divides a complete subscription from a external media provider into smaller subscriptions based on the part of access to content based on different categorization or duration of the subscription, which gives access to the content without advertisements.

19. Claim to invent and create, universal cross-platform media market place UCPMMP, which will allow free trade of media content across different platforms, regions and systems and will be powered by FPMCT.

20. Claim to invent and create, in content dynamic sponsorship place holders ICDSPH, which appear in certain places in the media content, that will be replaced by the product or promotion or entity, from which the credit was earned to not show the advertisements, rather show the product that sponsored the content dynamically, this is a pioneer way to inform users about the products and services without interrupting the experience.
